(19) United States
(12) Patent Application Publication
(10) Pub. No.: US 2011/0187638 A1
(43) Pub. Date: Aug. 4, 2011

(54) Interactive module applied in 3D interactive system and method

(76) Inventor: Tzu-Yi Chao, Hsin-Chu City (TW)

(21) Appl. No.: 12/784,512

(22) Filed: May 21, 2010

(30) Foreign Application Priority Data
Feb. 1, 2010 (TW) 099102790

(51) Int. Cl. G06F 3/01

(52) U.S. Cl. 345/156

(57) ABSTRACT

An interactive module applied in a 3D interactive system calibrates a location of an interactive component or calibrates a location and an interactive condition of a virtual object in a 3D image, according to a location of a user. In this way, even the location of the user changes so that the location of the virtual object seen by the user changes as well, the 3D interactive system still can correctly decide an interactive result according to the corrected location of the interactive component, or according to the corrected location and corrected interactive condition of the virtual object.

### BACKGROUND OF THE INVENTION

1. Field of the Invention

The present invention relates to a 3D interactive system, and more particularly, to a 3D interactive system utilizing 3D display system for interacting.

2. Description of the Prior Art

Conventionally, 3D display system is only for providing 3D images. As shown in FIG. 1, 3D display systems comprise naked eye 3D display systems and glass 3D display systems. The naked eye 3D display system 110 in the left part of FIG. 1 provides different images at different angles, such as DIM_{θ1}˜DIM_{θ8} in FIG. 1, so that a user receives a left image DIM_{L} (DIM_{θ4}) and a right image DIM_{R} (DIM_{θ5}) respectively, and accordingly obtains the 3D image provided by the naked eye 3D display system 110. The glass 3D display system 120 comprises a display screen 121 and an assistant glass 122. The display screen 121 provides a left image DIM_{L} and a right image DIM_{R}. The assistant glass 122 helps the two eyes of a user to receive the left image DIM_{L} and the right image DIM_{R} respectively so that the user obtains the 3D image.

However, the 3D image obtained from the 3D display system changes as the location of the user. Take the glass 3D display system 120 for example, as shown in FIG. 2 (the assistant glass 122 is not shown), the 3D image provided by the glass 3D display system 120 includes a virtual object VO (assuming the virtual object VO to be a tennis ball), wherein the locations of the virtual object VO in the left image DIM_{L} and the right image DIM_{R} are LOC_{ILVO} and LOC_{IRVO} respectively. It is assumed that the user's left eye is LOC_{1LE}, which forms a straight line L_{1L} to the location LOC_{ILVO} of the virtual object VO, and the user's right eye is LOC_{1RE}, which forms a straight line L_{1R} to the location LOC_{ILVO} of the virtual object VO. In this way, the location of the virtual object VO seen by the user is decided by the straight lines L_{1L} and L_{1R}. For example, when the straight lines L_{1L} and L_{1R} cross at LOC_{1CP}, the location of the virtual object VO seen by the user is LOC_{1CP}. Similarly, when the locations of the user's eyes respectively are LOC_{2LE} and LOC_{2RE}, which form the straight lines L_{2L} and L_{2R} respectively to the locations LOC_{ILVO} and LOC_{IRVO} of the virtual object VO, the location of the virtual object VO seen by the user is decided by the straight lines L_{2L} and L_{2R}. That is, the location of the virtual object VO seen by the user is the location LOC_{2CP} where the straight lines L_{2L} and L_{2R} cross.

Since the 3D image obtained from the 3D display system changes as the location of the user, when the user attempts to interact with the 3D display system through an interactive module (such as game console), incorrect results may occur. For example, a user plays tennis game through an interactive module (such as game console) with the 3D display system 120. The user holds an interactive component (such as a joystick) by hand for controlling the character in the tennis game to hit the tennis ball. The interactive console (game console) assumes the location of the user is in front of the 3D display system 120 and the locations of the user's eyes are LOC_{1LE} and LOC_{1RE} respectively. Meanwhile, the interactive module (game console) controls the 3D display system 120 to display the tennis ball locating at LOC_{ILVO} in the left image DIM_{L} and LOC_{IRVO} in the right image DIM_{R}. Therefore, the interactive module (game console) assumes the location of the 3D tennis seen by the user is LOC_{1CP} (as shown in FIG. 2). Furthermore, when the distance between the location where the swing motion (of the user) is detected and the location LOC_{1CP} is less than an interactive threshold distance D_{TH}, the interactive module (game console) determines the user hit the tennis ball. However, if the locations of the user's eyes are actually LOC_{2LE} and LOC_{2RE}, the location of the 3D tennis ball seen by the user is actually LOC_{2CP}. It is assumed that the distance between the locations LOC_{2CP} and LOC_{1CP} is longer than the interactive threshold distance D_{TH}. Thus, when the user controls the interactive component (joystick) to swing to the location LOC_{2CP}, the interactive module (game console) determines the user does not hit the tennis ball. In other words, although the location of the 3D tennis ball seen by the user actually is LOC_{2CP}, and the user controls the interactive component (joystick) to swing to the location LOC_{2CP}, the interactive module (game console) determines the user does not hit the tennis ball. Because of the distortion of the 3D image due to the change of the locations of the user's eyes, the relation between the user and the object is incorrectly determined by the interactive module (game console), which generates incorrect interactive result and is inconvenient.

### SUMMARY OF THE INVENTION

The present invention provides an interactive module applied in a 3D interactive system. The 3D interactive system has a 3D display system. The 3D display system is utilized for providing a 3D image. The 3D image has a virtual object. The virtual object has a virtual coordinate and an interaction determining condition. The interactive module comprises a positioning module, an interactive component, an interactive component positioning module, and an interaction determining circuit. The positioning module is utilized for detecting a location of a user in a scene so as to generate a 3D reference coordinate. The interactive component positioning module is utilized for detecting a location of the interactive component so as to generate a 3D interactive coordinate. The interaction determining circuit is utilized for converting the virtual coordinate into a corrected virtual coordinate according to the 3D reference coordinate, and deciding an interactive result between the interactive component and the 3D image according to the 3D interactive coordinate, the corrected virtual coordinate, and the interaction determining condition.

The present invention further provides an interactive module applied in a 3D interactive system. The 3D interactive system has a 3D display system. The 3D display system is utilized for providing a 3D image. The 3D image has a virtual object. The virtual object has a virtual coordinate and an interaction determining condition. The interactive module comprises a positioning module, an interactive component, an interactive component positioning module, and an interaction determining circuit. The positioning module is utilized for detecting a location of a user in a scene so as to generate a 3D reference coordinate. The interactive component positioning module is utilized for detecting a location of the interactive component so as to generate a 3D interactive coordinate. The interaction determining circuit is utilized for converting the 3D interactive coordinate into a corrected 3D interactive coordinate according to the 3D reference coordinate, and deciding an interactive result between the interactive component and the 3D image according to the corrected 3D interactive coordinate, the virtual coordinate, and the interaction determining condition.

The present invention further provides a method of deciding an interactive result of a 3D interactive system. The 3D interactive system has a 3D display system and an interactive component. The 3D display system is utilized for providing a 3D image. The 3D image has a virtual object. The virtual object has a virtual coordinate and an interaction determining condition. The method comprises detecting a location of a user in a scene so as to generate a 3D reference coordinate, detecting a location of the interactive component so as to generate a 3D interactive coordinate, and deciding the interactive result between the interactive component and the 3D image according to the 3D reference coordinate, the 3D interactive coordinate, the virtual coordinate, and the interaction determining condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating conventional 3D display systems.

FIG. 2 is a diagram illustrating that the 3D image provided by the conventional 3D display system varying with the location of the user.

FIG. 3 and FIG. 4 are diagrams illustrating a 3D interactive system according to an embodiment of the present invention.

FIG. 5 is a diagram illustrating a first embodiment of the correcting method of the present invention.

FIG. 6, FIG. 7, and FIG. 8 are diagrams illustrating the method which reduces the number of the search point that the interaction determining circuit has to process in the first embodiment of the correcting method of the present invention.

FIG. 9 and FIG. 10 are diagrams illustrating the second embodiment of the correcting method of the present invention.

FIG. 11 and FIG. 12 are diagrams illustrating a third embodiment of the correcting method of the present invention.

FIG. 13 is a diagram illustrating the 3D interactive system of the present invention controlling the displaying image and the sound effect.

FIG. 14 is a diagram illustrating an eye positioning module according to a first embodiment of the present invention.

FIG. 15 is a diagram illustrating an eye positioning circuit according to a first embodiment of the present invention.

FIG. 16 is a diagram illustrating an eye positioning module according to another embodiment of the present invention.

FIG. 17 is a diagram illustrating an eye positioning circuit according to another embodiment of the present invention.

FIG. 18 is a diagram illustrating an eye positioning circuit according to another embodiment of the present invention.

FIG. 19 and FIG. 20 are diagrams illustrating an eye positioning circuit according to another embodiment of the present invention.

FIG. 21 and FIG. 22 are diagrams illustrating an eye positioning circuit according to another embodiment of the present invention.

FIG. 23 is a diagram illustrating an eye positioning module according to another embodiment of the present invention.

FIG. 24 is a diagram illustrating a 3D scene sensor according to a first embodiment of the present invention.

FIG. 25 is a diagram illustrating an eye coordinate generating circuit according to a first embodiment of the present invention.

FIG. 26 is a diagram illustrating an eye coordinate generating circuit according to another embodiment of the present invention.

FIG. 27 is a diagram illustrating an eye coordinate generating circuit according to another embodiment of the present invention.

FIG. 28 is a diagram illustrating an eye coordinate generating circuit according to another embodiment of the present invention.

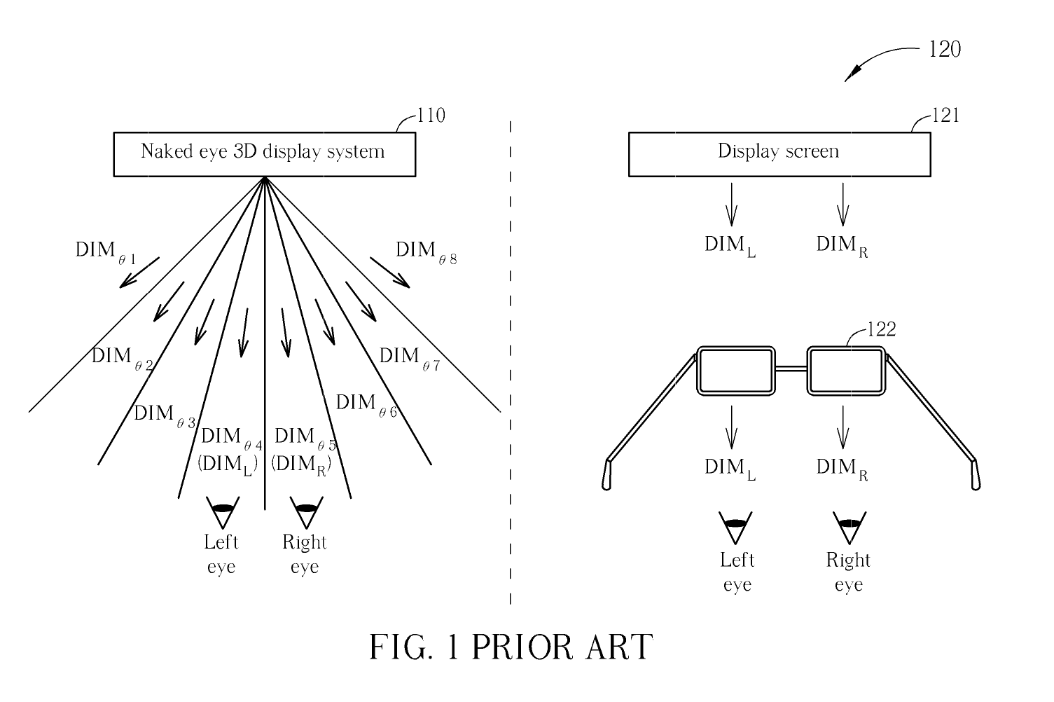

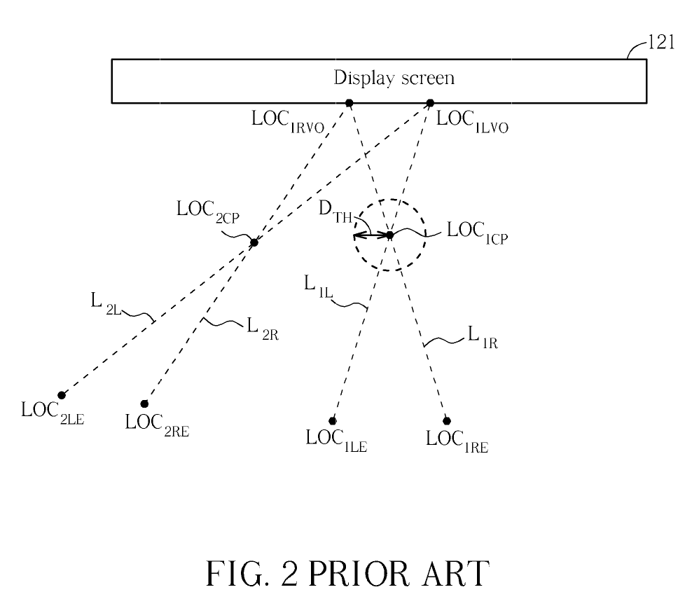

### DETAILED DESCRIPTION

The present invention provides a 3D interactive system for correcting the location of the interactive component or the location of the virtual object of the 3D image and the conditions for determining the interactions according to the location of the user (user). In this way, the 3D interactive system obtains correct interactive result according to the corrected location of the interactive component or the corrected location of the virtual object and the corrected conditions for determining the interactions.

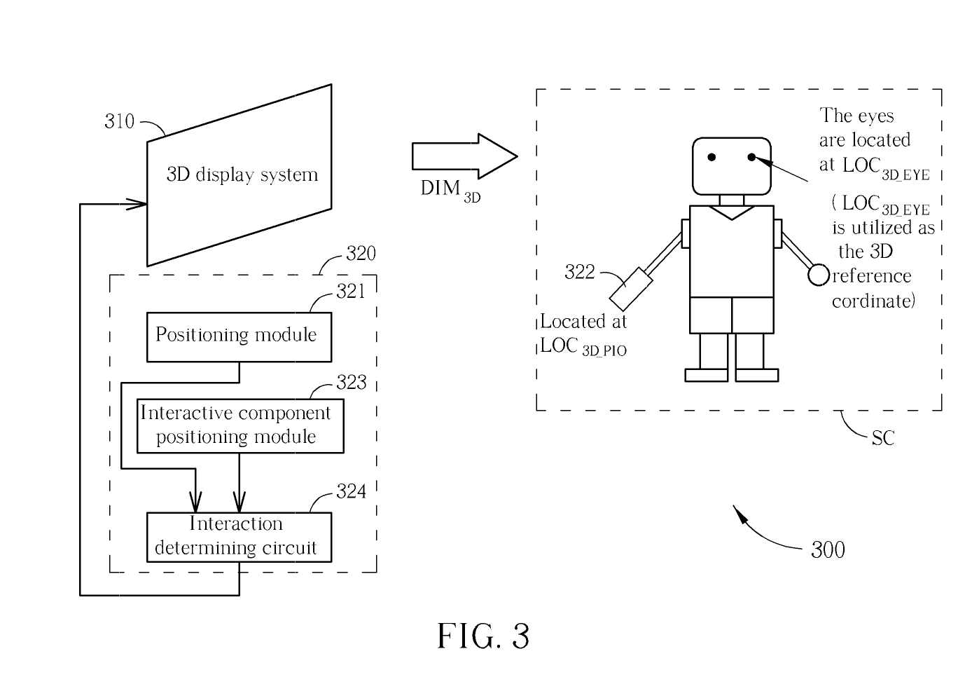

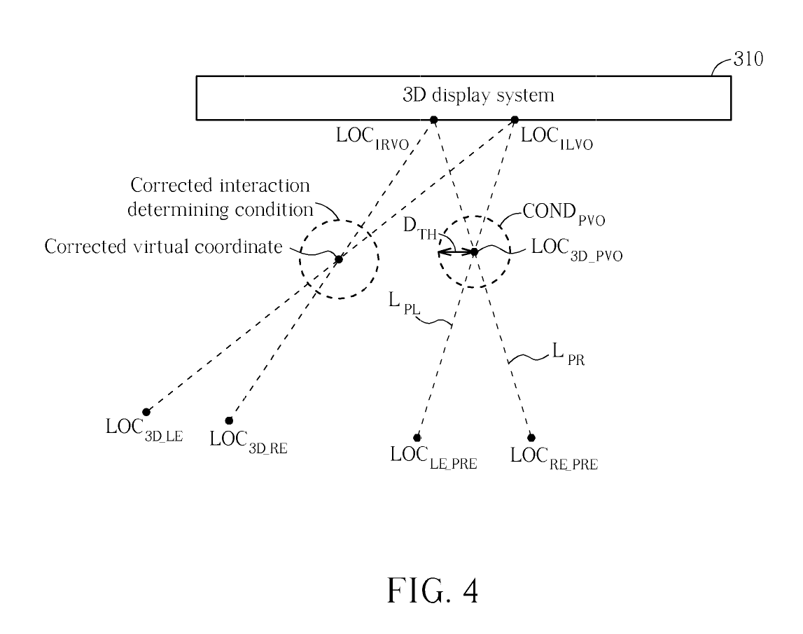

Please refer to FIG. 3 and FIG. 4. FIG. 3 and FIG. 4 are diagrams illustrating a 3D interactive system 300 according to an embodiment of the present invention. The 3D interactive system 300 includes a 3D display system 310 and an interactive module 320. The 3D display system 310 provides 3D image DIM_{3D}. 3D display system 310 can be realized with the naked eye 3D display system 110 or the glass 3D display system 120. The interactive module 320 includes a positioning module 321, an interactive component 322, an interactive component positioning module 323, and an interaction determining circuit 324. The positioning module 321 detects the location of a user in a scene SC for generating a 3D reference coordinate. The interactive component positioning module 323 detects the location of the interactive component 322 for generating a 3D interactive coordinate LOC_{3D}_{_{—}}_{PIO}. The interaction determining circuit 324 decides the interactive result RT between the interactive component 322 and the 3D image DIM_{3D} according to the 3D reference coordinate, the 3D interactive coordinate LOC_{3D}_{_{—}}_{PIO}, and the 3D image DIM_{3D}.

For brevity, it is assumed that the positioning module 321 is an eye positioning module. The eye positioning module 321 detects the locations of the eyes of a user in a scene SC for generating a 3D eye coordinate LOC_{3D}_{_{—}}_{EYE} as the 3D reference coordinate, wherein the 3D eye coordinate LOC_{3D}_{_{—}}_{EYE} includes a 3D left eye coordinate LOC_{3D}_{_{—}}_{LE} and a 3D right eye coordinate LOC_{3D}_{_{—}}_{RE}. In this way, the interaction determining circuit 324 decides the interactive result RT between the interactive component 322 and the 3D image DIM_{3D} according to the 3D eye coordinate LOC_{3D}_{_{—}}_{EYE}, the 3D interactive coordinate LOC_{3D}_{_{—}}_{PIO}, and the 3D image DIM_{3D}. However, the positioning module 321 is not limited to the eye positioning module. For example, the positioning module 321 can position the location of the user by detecting other features of the user (such as ear or mouth). The following is the detailed explanation for the 3D interactive system 300 of the present invention.

3D image DIM_{3D} is composed of the left image DIM_{L}and the right image DIM_{R}. It is assumed that the 3D image DIM_{3D} includes a virtual object VO. For example, if the user plays tennis game through the 3D interactive system 300, the virtual object VO can be tennis ball, and the user controls another virtual object (such as tennis racket) in the 3D image DIM_{3D} through the interactive component 322 to engage the tennis game. The virtual object VO includes a virtual coordinate LOC_{3D}_{_{—}}_{PVO} and an interactive determining condition COND_{PVO}. More particularly, the locations of the virtual object VO are LOC_{ILVO} and LOC_{IRVO} in the left image DIM_{L} and the right image DIM_{R} respectively. The interactive module 320 assumes the user is positioned at a reference location (such as the front of the 3D display system 310), and the location of the user's eyes equals to the predetermined eye coordinate LOC_{EYE}_{_{—}}_{PRE}, wherein the predetermined eye coordinate LOC_{EYE}_{_{—}}_{PRE} includes a predetermined left eye coordinate LOC_{LE}_{_{—}}_{PRE} and a predetermined right eye coordinate LOC_{RE}_{_{—}}_{PRE}. According to the straight line L_{PL} (formed by the predetermined left coordinate LOC_{LE}_{_{—}}_{PRE} and the location LOC_{ILVO} of the virtual object VO in the left image DIM_{L}) and the straight line L_{PR} (formed by the predetermined right coordinate LOC_{RE}_{_{—}}_{PRE} and the location LOC_{IRVO} of the virtual object VO in the right image DIM_{R}), the 3D interactive system 300 determines the location of the virtual object VO seen by the user from the predetermined eye coordinate LOC_{EYE}_{_{—}}_{PRE} to be LOC_{3D}_{_{—}}_{PVO} and sets the virtual coordinate of the virtual object VO to be LOC_{3D}_{_{—}}_{PVO}. More particularly, the user has a 3D image locating model MODEL_{LOC} for positioning the location of the component according to the images received by the eyes. That is, after the user receives the left image DIM_{L} and the right image DIM_{R}, the user positions the 3D image location of the virtual object VO by the 3D image locating model MODEL_{LOC}, according to the locations LOC_{ILVO} and LOC_{IRVO} of the virtual object VO respectively in the left image DIM_{L} and the right image DIM_{R}. For example, in the present invention, it is assumed that the 3D image locating model MODEL_{LOC} decides the 3D image location of the virtual object VO according to a first straight line (such as the straight line LP_{L}) formed by the location of the virtual object VO in the left image DIM_{L} (such as the location LOC_{ILVO}) and the location of the left eye of the user (such as the location of the predetermined left eye coordinate LOC_{LE}_{_{—}}_{PRE}) and a second straight line (such as the straight line L_{PR}) formed by the location of the virtual object VO in the right image DIM_{R} (such as the location LOC_{IRVO}) and the location of the right eye of the user (such as the location of the predetermined right eye coordinate LOC_{RE}_{_{—}}_{PRE}). When the first straight line and the second straight line cross at a cross point, the 3D image locating model MODEL_{LOC} sets the 3D image location of the virtual object VO to be the coordinate of the cross point; when the first and second straight lines do not cross, the 3D image locating model MODEL_{LOC} decides a reference middle point which has a minimum sum of the distances to the first and the second straight lines, and sets the 3D image location of the virtual object VO to be the coordinate of the reference middle point. The interactive determining condition COND_{PVO} of the virtual object VO is utilized by the interaction determining circuit 324 to determine the interactive result RT. For example, the interactive determining condition COND_{PVO} is set to represent “contact” when the distance between the location of the interactive component 322 and the virtual coordinate LOC_{3D}_{_{—}}_{PVO} is less than the interactive threshold distance D_{TH}, which means the interaction determining circuit 324 determines the tennis racket controlled by the interactive component 322 contacts the virtual object VO in the 3D image DIM_{3D} (such as hitting the tennis ball), and to be “not contact” when the distance between the location of the interactive component 322 and the virtual coordinate LOC_{3D}_{_{—}}_{PVO} is larger than the interactive threshold distance D_{TH}, which means the interaction determining circuit 324 determines the tennis racket controlled by the interactive component 322 does not contact the virtual object VO in the 3D image DIM3D (such as the racket not hitting the tennis ball).

In the present invention, the interaction determining circuit 324 decides the interactive result RT according to the 3D eye coordinate (3D reference coordinate) LOC_{3D}_{_{—}}_{EYE}, 3D interactive coordinate LOC_{3D}_{_{—}}_{PIO}, and the 3D image DIM_{3D}. More particularly, when the user does not see the 3D image DIM_{3D} from the predetermined eye coordinate LOC_{EYE}_{_{—}}_{PRE} assumed by the 3D interactive system 300, the location of the virtual object VO seen by the user changes and the shape of the virtual object VO changes, which result in incorrect interactive result RT. Therefore, the present invention provides three embodiments for correction and is explained in the following.

In the first embodiment of the present invention, the interaction determining circuit 324 corrects the location which the user actually engages interacting through the interactive component 322 according to the location of the user seeing the 3D image DIM_{3D} (3D eye coordinate LOC_{3D}_{_{—}}_{EYE}) for obtaining the correct interactive result RT. More particularly, the interaction determining circuit 324 calculates the location (corrected 3D interactive coordinate LOC_{3D}_{_{—}}_{CIO}) of the virtual object controlled by the interactive component 322, which is seen by the user when the locations of the user's eyes are the predetermined eye coordinates LOC_{EYE}_{_{—}}_{PRE}, according to the 3D image locating model MODE_{LOC}. Then, the interaction determining circuit 324 decides the interactive result RT when the locations of the user's eyes are the predetermined eye coordinates LOC_{EYE}_{_{—}}_{PRE} according to the corrected 3D interactive coordinate LOC_{3D}_{_{—}}_{CIO}, the virtual coordinate of the virtual object LOC_{3D}_{_{—}}_{PVO}, and the interaction determining condition COND_{PVO}. Because the interactive result RT does not change as the location of the user, the interactive result obtained by the interaction determining circuit is the interactive result RT seen by the user when the locations of the user's eyes are simulated at the 3D eye coordinate LOC_{3D}_{_{—}}_{EYE}.

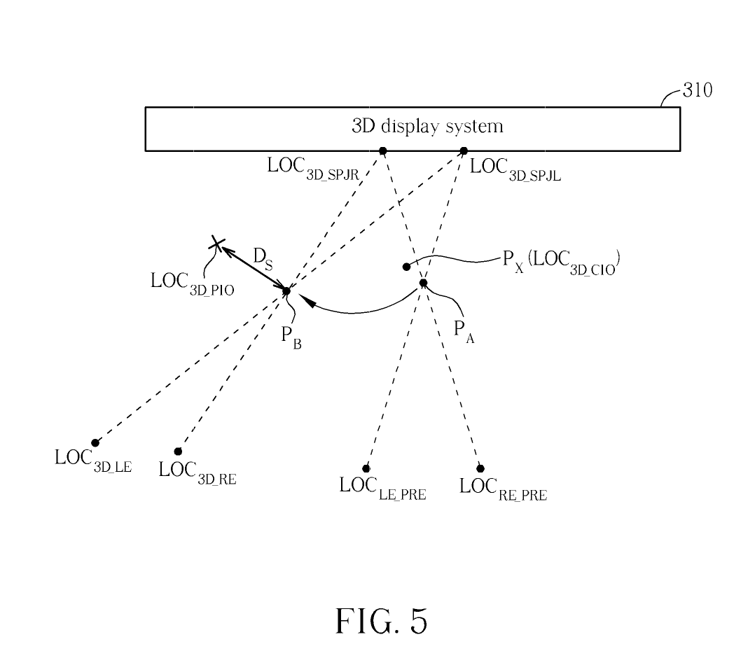

Please refer to FIG. 5. FIG. 5 is a diagram illustrating a first embodiment of the correcting method of the present invention. The interaction determining circuit 324, according to the 3D eye coordinate (3D reference coordinate) LOC_{3D}_{_{—}}_{EYE}, converts the 3D interactive coordinate LOC_{3D}_{_{—}}_{PIO} to the corrected 3D interactive coordinate LOC_{3D}_{_{—}}_{CIO}. More particularly, the interaction determining circuit 324, according to the 3D eye coordinate LOC_{3D}_{_{—}}_{EYE} and the 3D interactive coordinate LOC_{3D}_{_{—}}_{PIO}, calculates the location of the interactive component 322 seen by the user (corrected 3D interactive coordinate LOC_{3D}_{_{—}}_{CIO}) when the locations of the user's eyes are simulated at the predetermined eye coordinate LOC_{EYE}_{_{—}}_{PRE}. For example, a plurality of search points (such as the search point P_{A} shown in FIG. 5) exist in the coordinate system for the predetermined eye coordinate LOC_{EYE}_{_{—}}_{PRE}. The interaction determining circuit 324, according to the search point P_{A} and the predetermined eye coordinates LOC_{LE}_{_{—}}_{PRE} and LOC_{RE}_{_{—}}_{PRE}, obtains the left search projected coordinate LOC_{3D}_{_{—}}_{SPJL} that the search point P_{A} projects to the left image DIM_{L} and the right search projected coordinate LOC_{3D}_{_{—}}_{SPJR} that the search point P_{A} projects to the right image DIM_{R}. By the 3D image locating model MODEL_{LOC} assumed by the present invention, the interaction determining circuit 324, according to the search projected coordinates LOC_{3D}_{_{—}}_{SPJL} and LOC_{3D}_{_{—}}_{SPJR}, and the 3D eye coordinate LOC_{3D}_{_{—}}_{EYE}, obtains the point P_{B} corresponding to the search point P_{A} in the coordinate system of the 3D eye coordinate LOC_{3D}_{_{—}}_{EYE}, and further calculates the error distance D_{S} between the point P_{B} and the 3D interactive coordinate LOC_{3D}_{_{—}}_{PIO}. In this way, the interaction determining circuit 324, according to the manner described above, calculates error distances D_{S} corresponding to all the search points P in the coordinate system of the predetermined eye coordinate LOC_{EYE}_{_{—}}_{PRE}. When a search point (for example, P_{X}) corresponds to a minimal error distance D_{S}, the interaction determining circuit 324, according to the location of the search point P_{X}, decides the corrected 3D interactive coordinate LOC_{3D}_{_{—}}_{CIO}. Because when the locations of the user's eyes are at the 3D eye coordinates LOC_{3D}_{_{—}}_{EYE}, the locations of each virtual objects of the 3D image DIM_{3D} seen by the user are converted from the coordinate system of the predetermined eye coordinate LOC_{EYE}_{_{—}}_{PRE} to the coordinate system of the 3D eye coordinate LOC_{3D}_{_{—}}_{EYE}, when the corrected 3D interactive coordinate LOC_{3D}_{_{—}}_{CIO} is calculated by the method of FIG. 5, the converting direction of the coordinate system is the same as the converting directions of each virtual object of the 3D image DIM_{3D} seen by the user. Therefore, the error due to the conversion for the non-linear coordinate system can be reduced and the accuracy of the obtained corrected 3D interactive coordinate LOC_{3D}_{_{—}}_{CIO} is higher.

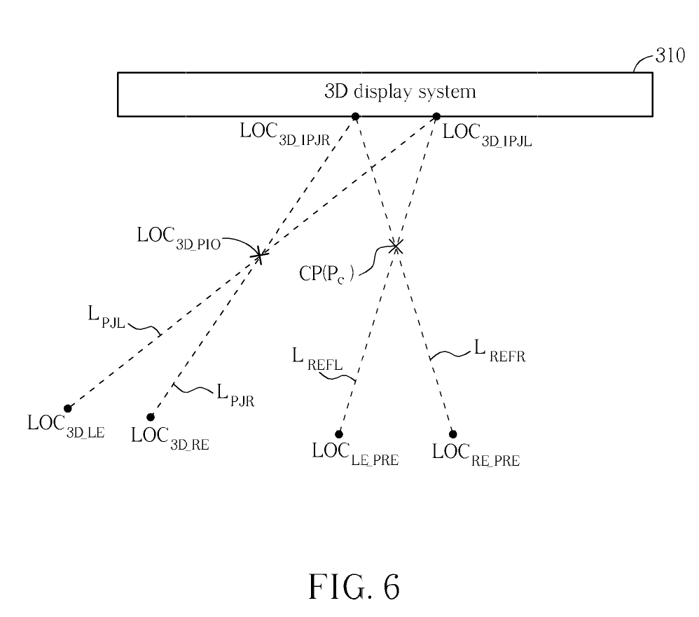

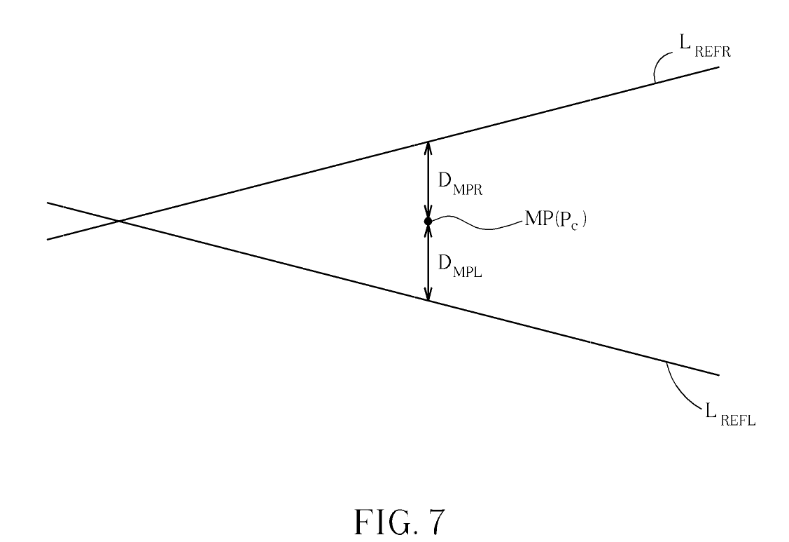

To reduce the computing resources required by the interaction determining circuit 324 for calculating the error distance D_{S} corresponding to the search point P in the coordinate system of the predetermined eye coordinate LOC_{EYE}_{_{—}}_{PRE} in the first embodiment of the correcting method of the present invention, the present invention further provides a simplified method for reducing the number of the search point P that the interaction determining circuit 324 has to process. Please refer to FIG. 6, FIG. 7, and FIG. 8. FIG. 6, FIG. 7, and FIG. 8 are diagrams illustrating the method which reduces the number of the search point P that the interaction determining circuit 324 has to process in the first embodiment of the correcting method of the present invention. The interaction determining circuit 324, according to the 3D eye coordinate LOC_{3D}_{_{—}}_{EYE}, converts the 3D interactive coordinate LOC_{3D}_{_{—}}_{PIO} in the coordinate system of the 3D eye coordinate LOC_{3D}_{_{—}}_{EYE} to a center point P_{C} in the coordinate system of the predetermined eye coordinate LOC_{EYE}_{_{—}}_{PRE}. Because the center point P_{C} corresponds to the 3D interactive coordinate LOC_{3D}_{_{—}}_{PIO} in the coordinate system of the 3D eye coordinate LOC_{3D}_{_{—}}_{EYE}, in most cases, the search point P_{X} with the minimal error distance D_{S} is close to the center point P_{C}. In other words, the interaction determining circuit 324 can only calculate the error distance D_{S} of the search point P close to the center point P_{C} for obtaining the search point P_{X} with the minimal error distance D_{S} and accordingly decide the corrected 3D interactive coordinate LOC_{3D}_{_{—}}_{CIO}.

More particularly, as shown in FIG. 6, a projecting straight line L_{PJL} can be formed by the 3D interactive coordinate LOC_{3D}_{_{—}}_{PIO} of the interactive component 322 and the 3D left coordinate LOC_{3D}_{_{—}}_{LE} of the user. The projecting straight line L_{PJL} crosses with the 3D display system 310 at the location LOC_{3D}_{_{—}}_{IPJL}, wherein the location LOC_{3D}_{_{—}}_{IPJL} is the 3D left interactive projected coordinate of the left image DIM_{L} which the interactive component 322 projects to the 3D display system 310. Similarly, another projecting straight line L_{PJR} can be formed by the 3D interactive coordinate LOC_{3D}_{_{—}}_{PIO} of the interactive component 322 and the 3D right coordinate LOC_{3D}_{_{—}}_{RE} of the user. The projecting straight line L_{PJR} crosses with the 3D display system 310 at the location LOC_{3D}_{_{—}}_{IPJR}, wherein the location LOC_{3D}_{_{—}}_{IPJR} is the 3D right interactive projected coordinate of the right image DIM_{L} which the interactive component 322 projects to the 3D display system 310. That is, the interaction determining circuit 324, according to the 3D eye coordinate LOC_{3D}_{_{—}}_{EYE} and the 3D interactive coordinate LOC_{3D}_{_{—}}_{PIO}, obtains the 3D left interactive projected coordinate LOC_{3D}_{_{—}}_{IPJL} and the 3D right interactive projected coordinate LOC_{3D}_{_{—}}_{IPJR} which the interactive component 322 projects on the 3D display system 310. The interaction determining circuit 324 determines a left reference straight line L_{REFL} according to the 3D left interactive projected coordinate LOC_{3D}_{_{—}}_{IPJL} and the predetermined left eye coordinate LOC_{LE}_{_{—}}_{PRE}, and determines a right reference straight L_{REFR} according to the 3D right interactive projected coordinate LOC_{3D}_{_{—}}_{IPJR} and the predetermined right eye coordinate LOC_{RE}_{_{—}}_{PRE}. The interaction determining circuit 324 obtains the center point P_{C} in the coordinate system of the predetermined eye coordinate LOC_{EYE}_{_{—}}_{PRE} according to the left reference straight line L_{REFL} and the right reference straight line L_{REFR}. For example, when the left reference straight line L_{REFL} and the right reference straight line L_{REFR} cross at the point CP (as shown in FIG. 6), the interaction determining circuit 324 decides the center point P_{C} according to the location of the point CP. When the left reference straight line L_{REFL} does not cross the right reference straight line L_{REFR} (as shown in FIG. 7), the interaction determining circuit 324 obtains a reference middle point MP having a minimal sum of distance to the left reference straight line L_{REFL} and to the right reference straight line L_{REFR} according to the left reference straight line L_{REFL} and the right reference straight line L_{REFR}, wherein the distance D_{MPL} between the reference middle point MP and the left reference straight line L_{REFL} equals the distance D_{MPR} between the reference middle point MP and the right reference straight line L_{REFR}. Under such condition, the reference middle point MP is the center point PC. When the interaction determining circuit 324 obtains the center point P_{C}, as shown in FIG. 8, the interaction determining circuit 324 decides a search range RA according to the center point P_{C}. The interaction determining circuit 324 only calculates the error distance D_{S} corresponding to the search points P in the search range RA. Consequently, compared with the full search method of FIG. 5, the method of FIG. 6, FIG. 7, and FIG. 8 further saves the computing resource when the interaction determining circuit 324 calculates the corrected 3D interactive coordinate LOC_{3D}_{_{—}}_{CIO}.

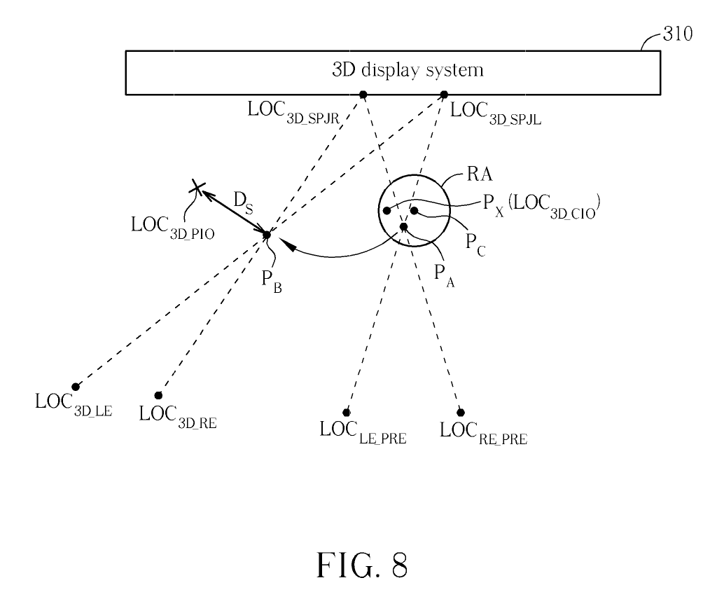

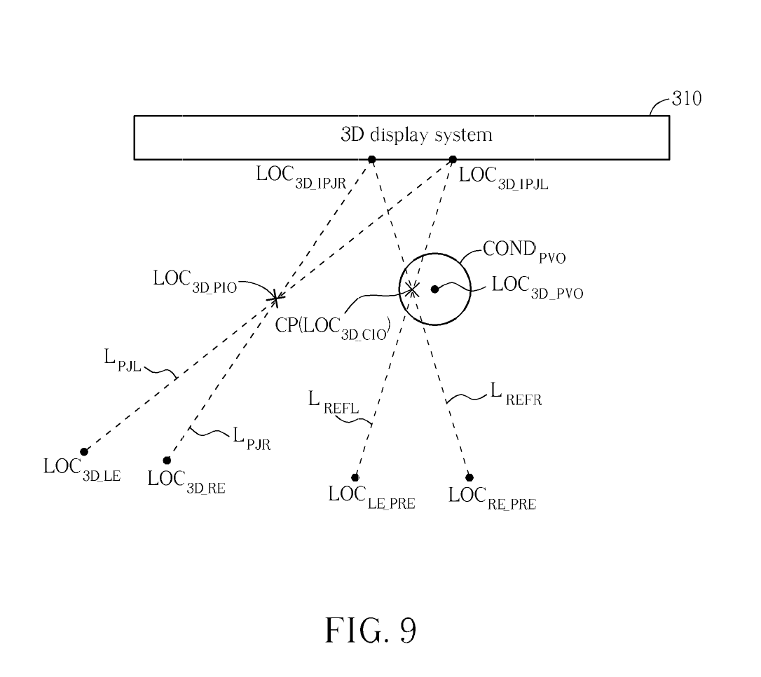

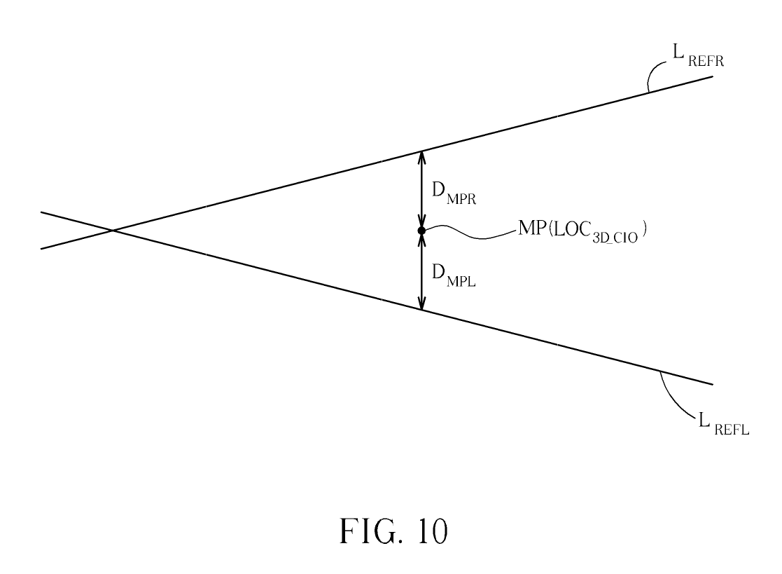

Please refer to FIG. 9 and FIG. 10. FIG. 9 and FIG. 10 are diagrams illustrating the second embodiment of the correcting method of the present invention. The interaction determining circuit 324 converts the 3D interactive coordinate LOC_{3D}_{_{—}}_{PIO} to the corrected 3D interactive coordinate LOC_{3D}_{_{—}}_{CIO} according to the 3D eye coordinate LOC_{3D}_{_{—}}_{EYE} (3D reference coordinate). More particularly, the interaction determining circuit 324 calculates the location of the interactive component 322 seen by the user (corrected 3D interactive coordinate LOC_{3D}_{_{—}}_{CIO}) according to the 3D eye coordinate LOC_{3D}_{_{—}}_{EYE} and the 3D interactive coordinate LOC_{3D}_{_{—}}_{PIO}. For example, as shown in FIG. 9, the projecting straight line L_{PJL} can be formed according to the 3D interactive coordinate LOC_{3D}_{_{—}}_{PIO} of the interactive component 322 and the 3D left eye coordinate LOC_{3D}_{_{—}}_{LE} of the user. The projecting straight line L_{PJL} and the 3D display system 310 cross at the location LOC_{3D}_{_{—IPJL}}, wherein the location LOC_{3D}_{_{—}}_{IPJL} is the 3D left interactive projected coordinate in the left image DIM_{L} of the 3D display system 310 which the interactive component 322 seen by the user projects. Similarly, the projecting straight line L_{PJR} and the 3D display system 310 cross at the location LOC_{3D}_{_{—}}_{IPJR}, wherein the location LOC_{3D}_{_{—}}_{IPJR} is the 3D right interactive projected coordinate in the right image DIM_{R} of the 3D display system 310 which the interactive component 322 seen by the user projects. That is, the interaction determining circuit 324 obtains the 3D left interactive projected coordinate LOC_{3D}_{_{—IPJL}} and the 3D right interactive projected coordinate LOC_{3D}_{_{—}}_{IPJR} which the interactive component 322 projects on the 3D display system 310 according to the 3D eye coordinate LOC_{3D}_{_{—}}_{EYE} and the 3D interactive coordinate LOC_{3D}_{_{—}}_{PIO}. The interaction determining circuit 324 decides a left reference straight line L_{REFL} according to the 3D left interactive projected coordinate LOC_{3D}_{_{—}}_{IPJL} and the predetermined left eye coordinate LOC_{LE}_{_{—}}_{PRE}, and decides a right reference straight line L_{REFR} according to the 3D right interactive projected coordinate LOC_{3D}_{_{—}}_{IPJR} and the predetermined right eye coordinate LOC_{RE}_{_{—}}_{PRE}. In this way, the interaction determining circuit 324, according to the left reference straight line L_{REFL} and the right reference straight line L_{REFR}, obtains the location of the interactive component 322 seen by the user (corrected 3D interactive coordinate LOC_{3D}_{_{—}}_{CIO}) when locations of the user's eyes are simulated at the predetermined eye coordinate LOC_{EYE}_{_{—}}_{PRE}. More particularly, when the left reference straight line L_{REFL} and the right reference straight line L_{REFR} cross at the point CP, the coordinate of the point CP is the corrected 3D interactive coordinate LOC_{3D}_{_{—}}_{CIO}; when the left reference straight line L_{REFL} does not cross the right reference straight line L_{REFR} (as shown in FIG. 10), the interaction determining circuit 324, according to the left reference straight line L_{RFEL} and the right reference straight line L_{RFER}, determines a reference middle point MP which has a minimum sum of the distances to the left reference straight line L_{RFEL} and the right reference straight line L_{RFER}, wherein the distance D_{MPL} between the reference middle point MP and the left reference straight line L_{RFEL} equals to the distance D_{MPR} between the reference middle point MP and the right reference straight line L_{RFER}. Meanwhile, the coordinate of the reference middle point MP can be treated as the location (corrected interactive coordinate LOC_{3D}_{_{—CIO}}) of the interactive component 322 seen by the user when the locations of the user's eyes are simulated at the predetermined eye coordinate LOC_{EYE}_{_{—}}_{PRE}. Therefore, the interaction determining circuit 324 can decides the interactive result RT according to the corrected 3D interactive coordinate LOC_{3D}_{_{—}}_{CIO}, the virtual coordinate LOC_{3D}_{_{—}}_{PVO} of the virtual object VO, and the interaction determining condition COND_{PVO}. Compared with the first embodiment of the correcting method of the present invention, in the second embodiment of the correcting method of the present invention, the interaction determining circuit 324 obtains the 3D left interactive projected coordinate LOC_{3D}_{_{—}}_{IPJL} and the 3D right interactive projected coordinate LOC_{3D}_{_{—}}_{IPJR} according to the 3D interactive coordinate LOC_{3D}_{_{—}}_{PIO} and the 3D eye coordinate LOC_{3D}_{_{—}}_{EYE}, and further obtains the corrected 3D interactive coordinate LOC_{3D}_{_{—}}_{CIO} according to the 3D left interactive projected coordinate LOC_{3D}_{_{—IPJL}} and the 3D right interactive projected coordinate LOC_{3D}_{_{—}}_{IPJR}. That is, in the second embodiment of the correcting method of the present invention, the 3D interactive coordinate LOC_{3D}_{_{—}}_{PIO} corresponding to the coordinate system of the 3D eye coordinate LOC_{3D}_{_{—}}_{EYE} is converted into a location corresponding to the coordinate system of the predetermined eye coordinate LOC_{EYE}_{_{—}}_{PRE}, and the location is utilized as the corrected 3D interactive coordinate LOC_{3D}_{_{—}}_{CIO}. In addition, in the second embodiment of the correcting method of the present invention, the conversion between the coordinate systems of the 3D eye coordinate LOC_{3D}_{_{—}}_{EYE} and the predetermined eye coordinate LOC_{EYE}_{_{—}}_{PRE} is non-linear. That is, the location in the coordinate system of the 3D eye coordinate LOC_{3D}_{_{—}}_{EYE}, which is converted from the corrected 3D interactive coordinate LOC_{3D}_{_{—}}_{CIO} according to the above-mentioned manner, is not equal to the 3D interactive coordinate LOC_{3D}_{_{—}}_{PIO}. Thus, compared with the first embodiment of the correcting method of the present invention, the corrected 3D interactive coordinate LOC_{3D}_{_{—}}_{CIO} obtained by the second embodiment of the correcting method of the present invention is an approximate value. However, by means of the second embodiment of the correcting method of the present invention, the interaction determining circuit 324 does not have to calculate error distance DS corresponding to the search point P. As a result, the computing resource required by the interaction determining circuit 324 is reduced.

In the third embodiment of the correcting method of the present invention, the interaction determining circuit 324 corrects the 3D image DIM_{3D} (such as the virtual coordinate LOC_{3D}_{_{—}}_{PVO} and the interaction determining condition COND_{PVO}) according to the locations of the user's eyes (such as the 3D left eye coordinate LOC_{3D}_{_{—}}_{LE} and the 3D right eye coordinate LOC_{3D}_{_{—}}_{RE} shown in FIG. 4), so as to obtain the correct interactive result RT. More particularly, the interaction determining circuit 324, according to the 3D eye coordinate LOC_{3D}_{_{—}}_{EYE} (the 3D left eye coordinate LOC_{3D}_{_{—}}_{LE} and the 3D right eye coordinate LOC_{3D}_{_{—}}_{RE}), the virtual coordinate LOC_{3D}_{_{—}}_{PVO} and the interaction determining condition COND_{PVO}, calculates the actual location of the virtual object VO that the user sees and the actual interaction determining condition that the user observes when the user's eyes are located at 3D eye coordinate LOC_{3D}_{_{—}}_{EYE}. In this way, the interaction determining circuit 324 can decide the interactive result RT correctly according to the location of the interactive component 322 (3D interactive coordinate LOC_{3D}_{_{—}}_{PIO}), the actual location of the virtual object VO that the user sees (as the corrected virtual coordinate shown in FIG. 4), and the actual interaction determining condition that the user observes (as the corrected interaction determining condition shown in FIG. 4).

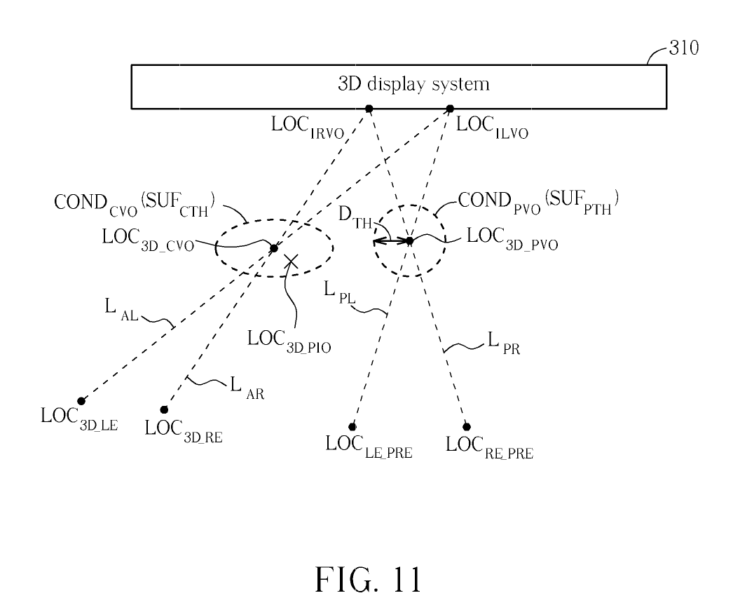

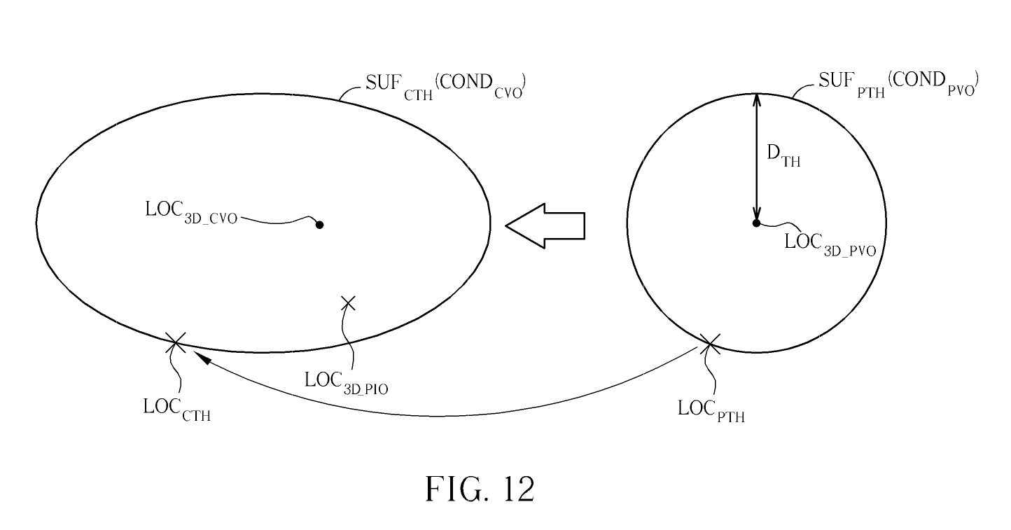

Please refer to FIG. 11 and FIG. 12. FIG. 11 and FIG. 12 are diagrams illustrating a third embodiment of the correcting method of the present invention. In the third embodiment of the correcting method of the present invention, the interaction determining circuit 324 corrects the 3D image DIM_{3D} according to the 3D eye coordinate LOC_{3D}_{_{—}}_{EYE} (3D reference coordinate), so as to obtain the correct interactive result RT. More particularly, the interaction determining circuit 324 converts the virtual coordinate LOC_{3D}_{_{—}}_{PVO} of the virtual object VO into a corrected virtual coordinate LOC_{3D}_{_{—}}_{CVO} according to the 3D eye coordinate LOC_{3D}_{_{—}}_{EYE} (3D reference coordinate). The interaction determining circuit 324 also converts the interaction determining condition COND_{PVO} into a corrected interaction determining condition COND_{CVO} according to the 3D eye coordinate LOC_{3D}_{_{—EYE}} (3D reference coordinate). In this way, the interaction determining circuit 324 decides the interactive result RT according to the 3D interactive coordinate LOC_{3D}_{_{—}}_{PIO}, the corrected virtual coordinate LOC_{3D}_{_{—}}_{CVO}, and the corrected interaction determining condition COND_{CVO}. For example, as shown in FIG. 11, the user receives the 3D image DIM_{3D} at the 3D eye coordinate LOC_{3D}_{_{—}}_{EYE} (the 3D left eye coordinate LOC_{3D}_{_{—}}_{LE} and the 3D right eye coordinate LOC_{3D}_{_{—}}_{RE}). Thus, the interaction determining circuit 324, according to the straight line L_{AL} (between the 3D left eye coordinate LOC_{3D}_{_{—}}_{LE} and the location LOC_{ILVO} of the virtual object VO shown in the left image DIM_{L}) and the straight line L_{AR} (between 3D right eye coordinate LOC_{3D}_{_{—}}_{RE} and the location LOC_{IRVO} of the virtual object VO shown in the right image DIM_{R}), obtains the actual location of the virtual object VO the user sees at the 3D eye coordinate LOC_{3D}_{_{—}}_{EYE} is LOC_{3D}_{_{—}}_{CVO}. In this way, the interaction determining circuit 324 can correct the virtual coordinate LOC_{3D}_{_{—}}_{PVO} according to the 3D eye coordinate LOC_{3D}_{_{—}}_{EYE} to obtain the actual location of the virtual object VO that the user sees. As shown in FIG. 12, the interaction determining condition COND_{PVO} is determined according to the interactive threshold distance D_{TH} and the location of the virtual object VO. Hence, the interaction determining condition COND_{PVO} is a threshold surface SUF_{PTH}, wherein the center of the threshold surface SUF_{PTH} is located at the location of the virtual object VO, and the radius of the threshold surface SUF_{PTH} equals to the interactive threshold distance D_{TH}. When the interactive component 322 is within the region covered by the threshold surface SUF_{PTH} or the interactive component 322 is in contact with the threshold surface SUF_{PTH}, the interaction determining circuit 324 decides the interactive result RT representing “contact”; when the interactive component 322 is out of the threshold surface SUF_{PTH}, the interaction determining circuit 324 decides the interactive result RT representing “not contact”. The threshold surface SUF_{PTH} is formed by a plurality of threshold points P_{TH}. Each threshold point P_{TH} is located at the corresponding virtual coordinate LOC_{PTH}. As a result, by means of the method illustrated in FIG. 11, the interaction determining circuit 324, according to the 3D eye coordinate LOC_{3D}_{_{—}}_{EYE}, can obtain the actual location of each threshold point P_{TH} that the user sees (the corrected virtual coordinate LOC_{CTH}). In this way, the corrected threshold surface SUF_{CTH} is formed by combining the corrected virtual coordinate LOC_{CTH} of each threshold points P_{TH}. Meanwhile, the corrected threshold surface SUF_{CTH} is the corrected interaction determining condition COND_{COV}. That is, when the 3D interactive coordinate LOC_{3D}_{_{—}}_{PIO} of the interactive component 322 is within region covered by the corrected threshold surface SUF_{CTH}, the interaction determining circuit 324 decides the interactive result RT representing “contact” (as shown in FIG. 12). In this way, the interaction determining circuit 324 can correct the 3D image DIM_{3D} (the virtual coordinate LOC_{3D}_{_{—PVO}} and the interaction determining condition COND_{PVO}) according to the 3D eye coordinate LOC_{3D}_{_{—}}_{EYE}, so as to obtain the actual location of the virtual object VO that the user sees (the corrected virtual coordinate LOC_{3D}_{_{—}}_{CVO}) and the actual interaction determining condition that the user observes (the corrected interaction determining condition COND_{CVO}). Consequently, the interaction determining circuit 324 can correctly decide the interactive result RT according to the 3D interactive coordinate LOC_{3D}_{_{—}}_{PIO} of the interactive component 322, the corrected virtual coordinate LOC_{3D}_{_{—}}_{CVO}, and the corrected interaction determining condition COND_{CVO}.

In general case, the difference between the interaction determining condition COND_{POV} and the corrected interaction determining condition COND_{COV} is not apparent. For example, when the threshold surface SUF_{PTH} is a sphere with a radius D_{TH}, the corrected threshold surface SUF_{CTH} is also a sphere with a radius around D_{TH}. Hence, in the third embodiment of the correcting method of the present invention, instead of correcting the virtual coordinate LOC_{3D}_{_{—}}_{PVO} and the interaction determining condition COND_{PVO}, the interaction determining circuit 324 can chose only to correct the virtual coordinate LOC_{3D}_{_{—}}_{PVO} for saving the computing resource required by the interaction determining circuit 324. In other words, the interaction determining circuit 324 can calculate the interactive result RT according to the 3D interactive coordinate LOC_{3D}_{_{—}}_{PIO}, the corrected virtual coordinate LOC_{3D}_{_{—}}_{CVO}, and the original interaction determining condition COND_{PVO}.

In addition, in the third embodiment of the correcting method of the present invention, the interaction determining circuit 324 corrects the 3D image DIM_{3D} (the virtual coordinate LOC_{3D}_{_{—}}_{PVO} and the interaction determining condition COND_{PVO}) according to the location of the user (3D eye coordinate LOC_{3D}_{_{—}}_{EYE}), so as to obtain the correct interactive result RT. Therefore, in the third embodiment of the correcting method of the present invention, if the 3D image DIM_{3D} has a plurality of virtual objects (for example, virtual objects VO₁˜VO_{M}), the interaction determining circuit 324 has to calculate the corrected virtual coordinate and the corrected interaction determining condition of each virtual object VO₁˜VO_{M}. In other words, the amount of the data processed by the interaction determining circuit 324 will increase when the number of the virtual objects increases. However, in the first and the second embodiments of the correcting method of the present invention, the interaction determining condition 324 corrects the location of the interactive component 322 (3D interactive coordinate LOC_{3D}_{_{—}}_{PIO}) according to the location of the user (3D eye coordinate LOC_{3D}_{_{—}}_{EYE}), so as to obtain the correct interactive result RT. Thus, in the first and the second embodiments of the correcting method of the present invention, the interaction determining circuit 324 only has to calculate the corrected 3D interactive coordinate LOC_{3D}_{_{—}}_{CIO} of the interactive component 322. In other words, compared with the third embodiments of the correcting method of the present invention, in the first and the second embodiments of the correcting method of the present invention, even if the number of the virtual objects increases, the amount of the data processed by the interaction determining circuit 324 keeps unchanged.

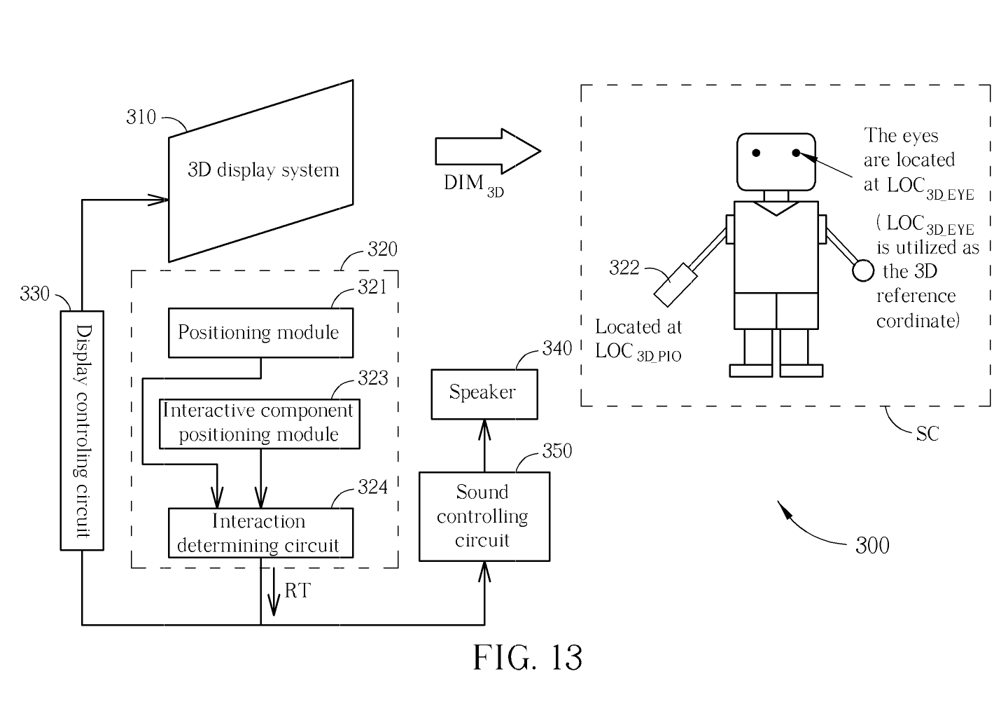

Please refer to FIG. 13. FIG. 13 is a diagram illustrating the 3D interactive system 300 of the present invention controlling the visual sound effect. The 3D interactive system 300 further includes a display controlling circuit 330, a speaker 340, and a sound controlling circuit 350. The display controlling circuit 330 adjusts the 3D image DIM_{3D} provided by the 3D display system 310 according to the interactive result RT. For example, when the interaction determining circuit 324 decides the interactive result RT representing “contact”, the display controlling circuit 330 controls the 3D display system 310 to display the 3D image DIM_{3D} which shows the interactive component 322 (corresponding to the tennis racket) hits the virtual object VO (such as the tennis ball). The sound controlling circuit 350 adjusts the sound provided by the speaker 340 according to the interactive result RT. For example, when the interaction determining circuit 324 determines the interactive result RT representing “contact”, the sound controlling circuit 350 controls the speaker 340 to output the sound of the interactive component 322 (corresponding to the tennis racket) hitting the virtual object VO (such as the tennis ball).

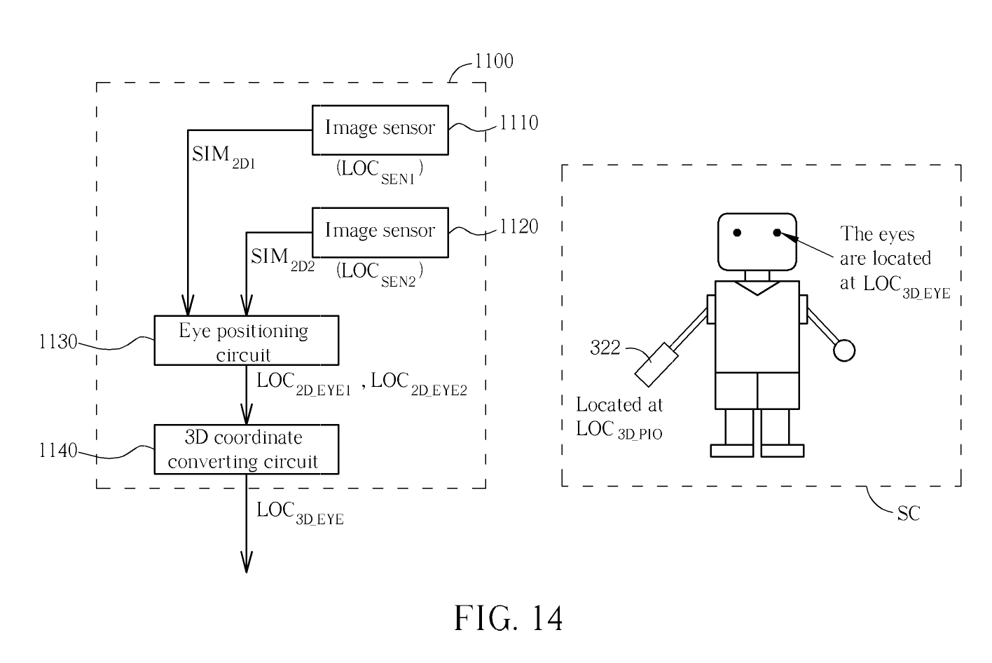

Please refer to FIG. 14. FIG. 14 is a diagram illustrating an eye positioning module 1100 according to an embodiment of the present invention. The eye positioning module 1100 includes image sensors 1110 and 1120, an eye positioning circuit 1130, and a 3D coordinate converting circuit 1140. The image sensors 1110 and 1120 are utilized for sensing the scene SC including the location of the user so as to generate 2D sensing images SIM_{2D1} and SIM_{2D2} respectively. The image sensor 1110 is disposed at a sensing location LOC_{SEN1}. The image sensor 1120 is disposed at a sensing location LOC_{SEN2}. The eye positioning circuit 1130 obtains a 2D eye coordinate LOC_{2D}_{_{—}}_{EYE1} of the user's eyes in the 2D sensing image SIM_{2D1} and a 2D eye coordinate LOC_{2D}_{_{—}}_{EYE2} of the user's eyes in the 2D sensing image SIM_{2D1} according to the 2D sensing images SIM_{2D1} and SIM_{2D2}, respectively. The 3D coordinate converting circuit 1140 calculates the 3D eye coordinate LOC_{3D}_{_{—}}_{EYE} of the user's eyes according to the 2D eye coordinates LOC_{2D}_{_{—}}_{EYE1} and LOC_{2D}_{_{—}}_{EYE2}, the sensing location LOC_{SEN1} of the image sensor 1110, and the sensing location LOC_{SEN2} of the image sensor 1120, wherein the operation principle of the 3D coordinate converting circuit 1140 is well known to those skilled in the art, and is omitted for brevity.

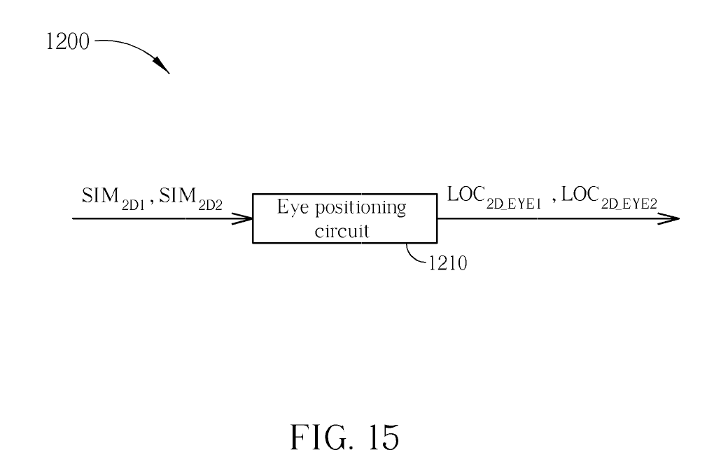

Please refer to FIG. 15. FIG. 15 is a diagram illustrating an eye positioning circuit 1200 according to an embodiment of the present invention. The eye positioning circuit 1200 includes an eye detecting circuit 1210. The eye detecting circuit 1210 detects the user's eyes in the 2D sensing image SIM_{2D1} to obtain the 2D eye coordinate LOC_{2D}_{_{—}}_{EYE1}, and detects the user's eyes in the 2D sensing image SIM_{2D2} to obtain the 2D eye coordinate LOC_{2D}_{_{—}}_{EYE2}. The operation principle of eye detection is well known to those skilled in the art, and is omitted for brevity.

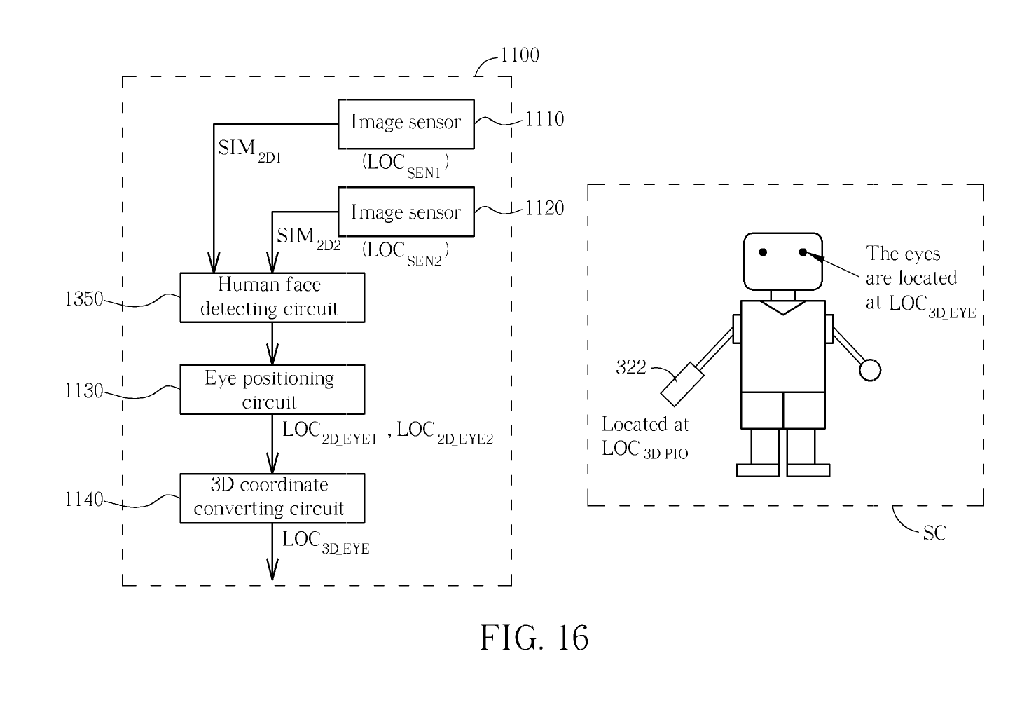

Please refer to FIG. 16. FIG. 16 is a diagram illustrating an eye positioning module 1300 according to an embodiment of the present invention. Compared with the eye positioning module 1100, the eye positioning module 1300 further includes a human face detecting circuit 1350. The human face detecting circuit 1350 determines the range of the human face HM₁ of the user in the 2D sensing image SIM_{2D1} and the range of the human face HM₂ of the user in the 2D sensing image SIM_{2D2}. The operation principle of the human face detection is well known to those skilled in the art, and is omitted for brevity. By means of the human face detecting circuit 1350, the eye positioning circuit 1130 only has to process the data of the range of the human faces HM₁ and HM₂ for obtaining the 2D eye coordinates LOC_{2D}_{_{—}}_{EYE1} and LOC_{2D}_{_{—}}_{EYE2}, respectively. Consequently, compared with the eye positioning module 1100, in the eye positioning module 1300, the amount of the data that the eye positioning circuit 1120 has to process in the 2D sensing images SIM_{2D1} and SIM_{2D2} is reduced, increasing the processing speed of the eye positioning module.

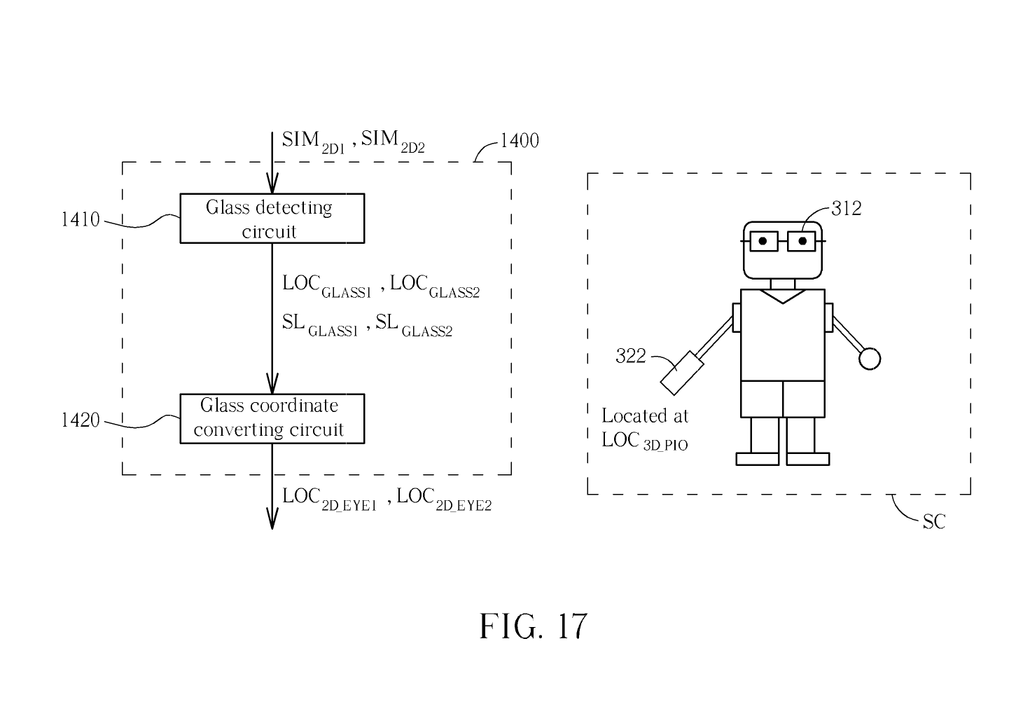

In addition, when the 3D display system 310 is realized with the glass 3D display system, it is possible that the user's eyes are blocked by the assistant glass of the glass 3D display system, so that the user's eyes can not be detected. Therefore, in FIG. 17, the present invention further provides an eye positioning circuit 1400 according to another embodiment of the present invention. It is assumed that the 3D display system 310 includes a display screen 311 and an assistant glass 312. The user wears the assistant glass 312 to receive the left image DIM_{L} and the right image DIM_{R} provided by the display screen 311. The eye positioning circuit 1400 includes a glass detecting circuit 1410 and a glass coordinate converting circuit 1420. The glass detecting circuit 1410 detects the assistant glass 312 in the 2D sensing image SIM_{2D1} to obtain a 2D glass coordinate LOC_{GLASS1} and a glass slope SL_{GLASS1}, and the glass detecting circuit 1410 detects the assistant glass 312 in the 2D sensing image SIM_{2D2} to obtain a 2D glass coordinate LOC_{GLASS2} and a glass slope SL_{GLASS2}. The glass coordinate converting circuit 1420 calculates the 2D eye coordinates LOC_{2D}_{_{—}}_{EYE1} and LOC_{2D}_{_{—}}_{EYE2} according to the 2D glass coordinates LOC_{GLASS1} and LOC_{GLASS1}, glass slopes SL_{GLASS1} and SL_{GLASS2}, and a predetermined eye spacing D_{EYE}, wherein the predetermined eye spacing D_{EYE} indicates the eye spacing of the user, and the predetermined eye spacing D_{EYE} is a value that the user previously inputs to the 3D interactive system 300 or a default value in the 3D interactive system 300. In this way, even if the eye of the user are blocked by the glass, the eye positioning module of the present invention still can obtain the 2D eye coordinates LOC_{2D}_{_{—}}_{EYE1} and LOC_{2D}_{_{—}}_{EYE2} of the user by means of the eye positioning circuit 1400.

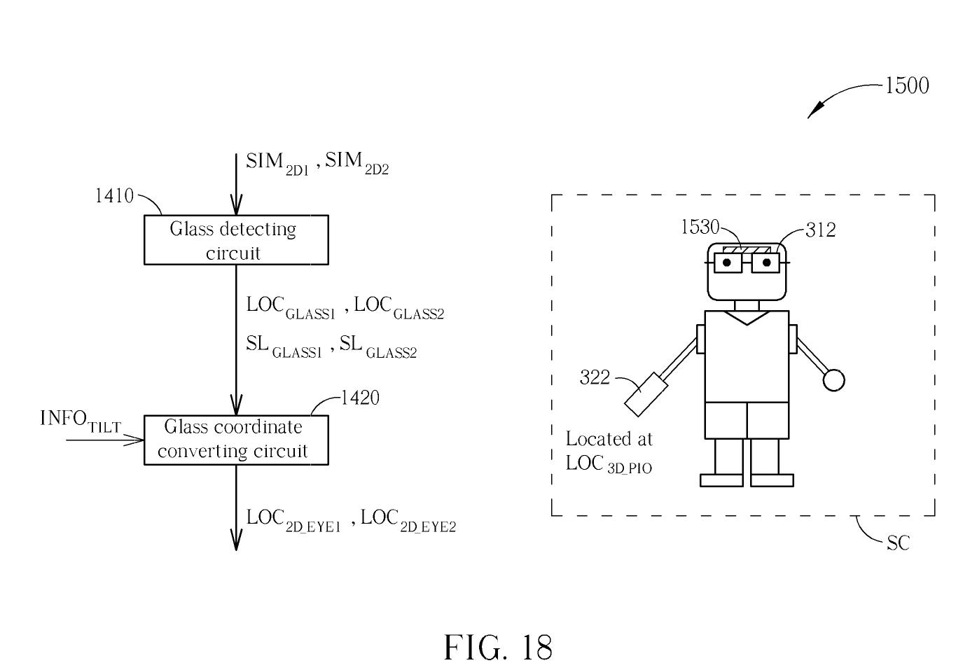

Please refer to FIG. 18. FIG. 18 is a diagram illustrating an eye positioning circuit 1500 according to another embodiment of the present invention. Compared with the eye positioning circuit 1400, the eye positioning circuit 1500 further includes a tilt detector 1530. The tilt detect 1530 is disposed on the assistant glass 312. The tilt detector 1530 generates a tilt information INFO_{TILT} according to the tilt angle of the assistant glass 312. For example, the tilt detector 1530 is a gyroscope. When the number of the pixels corresponding to the assistant glass 312 in the 2D sensing images SIM_{2D1} and SIM_{2D2} is less, it is possible that the glass slopes SL_{GLASS1} and SL_{GLASS2} calculated by the eye detecting circuit 1410 are incorrect. Hence, by means of the tilt information INFO_{TILT} provided by the tilt detector 1530, the glass coordinated converting circuit 1420 can calibrate the glass slopes SL_{GLASS1} and SL_{GLASS2} calculated by the eye detecting circuit 1410. For instance, the glass coordinate converting circuit 1420 corrects the glass slopes SL_{GLASS1} and SL_{GLASS2} calculated by the eye detecting circuit 1410 according to the tilt information INFO_{TILT} so as to generate corrected glass slopes SL_{GLASS1}_{_{—}}_{C} and SL_{GLASS2}_{_{—}}_{C}. In this way, the glass coordinate converting circuit 1420 calculates the 2D eye coordinates LOC_{2D}_{_{—}}_{EYE1} and LOC_{2D}_{_{—}}_{EYE2} of the user according to the 2D glass coordinates LOC_{GLASS1} and LOC_{GLASS2}, the corrected glass slopes SL_{GLASS1}_{_{—}}_{C} and SL_{GLASS2}_{_{—}}_{C}, and the predetermined eye spacing D_{EYE}. In this way, compared with the eye positioning circuit 1400, in the eye positioning circuit 1500, the glass coordinate converting circuit 1420 calibrates the error of the glass detecting circuit 1410 calculating the glass slopes SL_{GLASS1} and SL_{GLASS2}, so that the glass coordinate converting circuit 1420 can more correctly calculate the 2D eye coordinates LOC_{2D}_{_{—}}_{EYE1} and LOC_{2D}_{_{—}}_{EYE2} of the user.

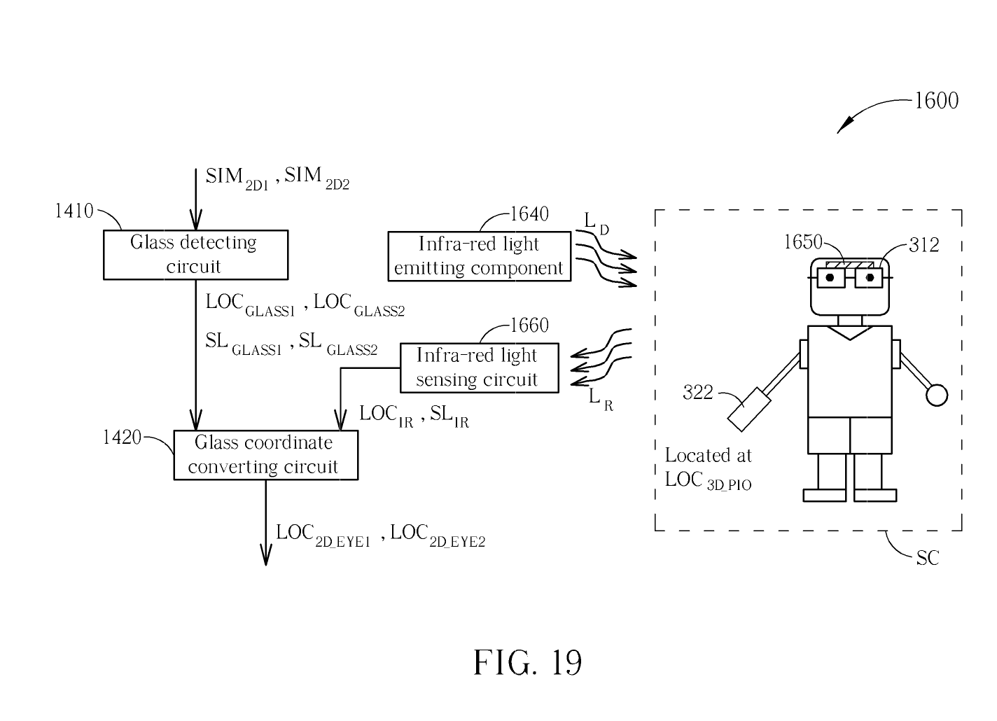

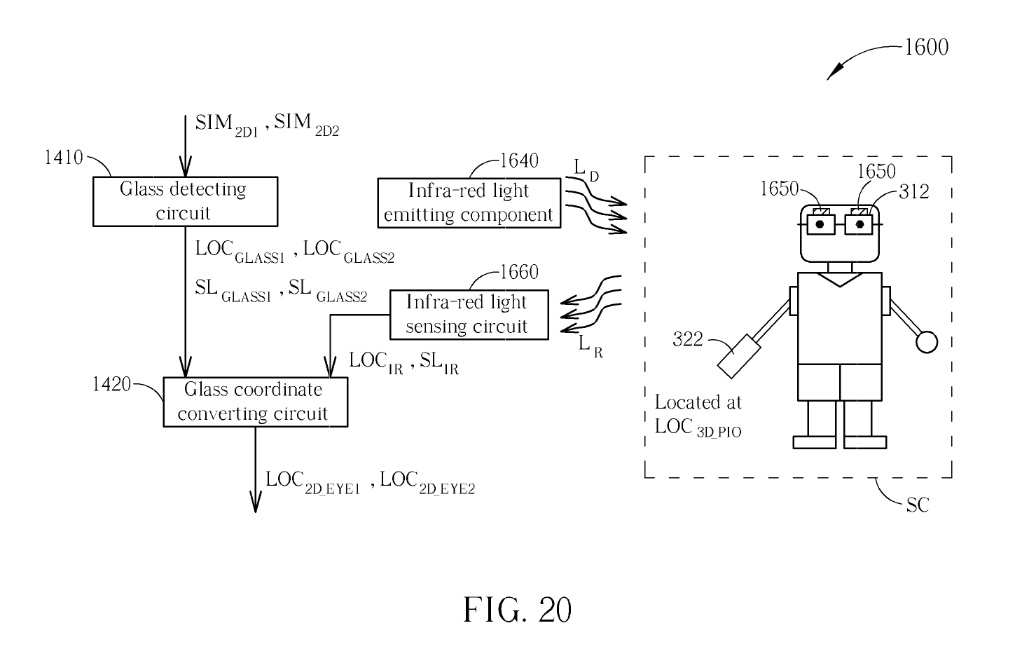

Please refer to FIG. 19. FIG. 19 is a diagram illustrating an eye positioning circuit 1600 according to another embodiment of the present invention. Compared with the eye positioning circuit 1400, the eye positioning circuit 1600 further includes an infra-red light emitting component 1640, an infra-red light reflecting component 1650, and an infra-red light sensing circuit 1660. The infra-red light emitting component 1640 emits a detecting light L_{D} to the scene SC. The infra-red reflecting component 1650 is disposed on the assistant glass 312 for reflecting the detecting light L_{D} so as to generate a reflecting light L_{R}. The infra-red light sensing circuit 1660 generates a 2D infra-red coordinate LOC_{IR} corresponding to the location of the assistant glass 312 and an infra-red light slope SL_{IR} corresponding to the tilt angle of the assistant glass 312 according to the reflecting light L_{R}. The glass coordinate converting circuit 1420 can correct the glass slopes SL_{GLASS1} and SL_{GLASS2} according to the information (the 2D infra-red light coordinate LOC_{IR} and the infra-red light slope SL_{IR}) provided by the infra-red light sensing circuit 1660 so as to generate corrected glass slopes SL_{GLASS1}_{_{—}}_{C} and SL_{GLASS}_{_{—}}_{C}, which is similar to the manner illustrated in FIG. 18. In this way, compared with the eye positioning circuit 1400, in the eye positioning circuit 1600, the glass coordinate converting circuit 1420 can calibrate the error of the glass detecting circuit 1410 calculating the glass slopes SL_{GLASS1} and SL_{GLASS2}, so that the glass coordinate converting circuit 1420 can more correctly calculate the 2D eye coordinates LOC_{2D}_{_{—}}_{EYE1} and LOC_{2D}_{_{—}}_{EYE2} of the user. In addition, the eye positioning circuit 1600 may include more than one infra-red light reflecting component 1650. For example, in FIG. 20, the eye positioning circuit 1600 includes two infra-red light reflecting components 1650 respectively disposed at the locations corresponding to the user's eyes. In FIG. 20, the two infra-red light reflecting components 1650 are respectively disposed above the user's eyes. The eye positioning circuit 1600 of FIG. 19 includes only one infra-red light reflecting component 1650, so the infra-red light sensing circuit 1660 has to detect the orientation of the infra-red light reflecting component 1650 for calculating the infra-red light slope SL_{IR}. However, in FIG. 20, when the infra-red light sensing circuit 1660 detects the reflecting light L_{R} generated by the two infra-red light reflecting components 1650, the infra-red light sensing circuit 1660 obtains the locations of the two infra-red light reflecting components 1650. In this way, the infra-red light sensing circuit 1660 can calculate the infra-red light slope SL_{IR} according to the locations of the two infra-red light reflecting components 1650. Thus, by means of the eye positioning circuit 1600 of FIG. 20, the infra-red light slope SL_{IR} are more easily and more accurately calculated, so that the 2D eye coordinates LOC_{2D}_{_{—}}_{EYE1} and LOC_{2D}_{_{—}}_{EYE2} of the user can be more correctly calculated.

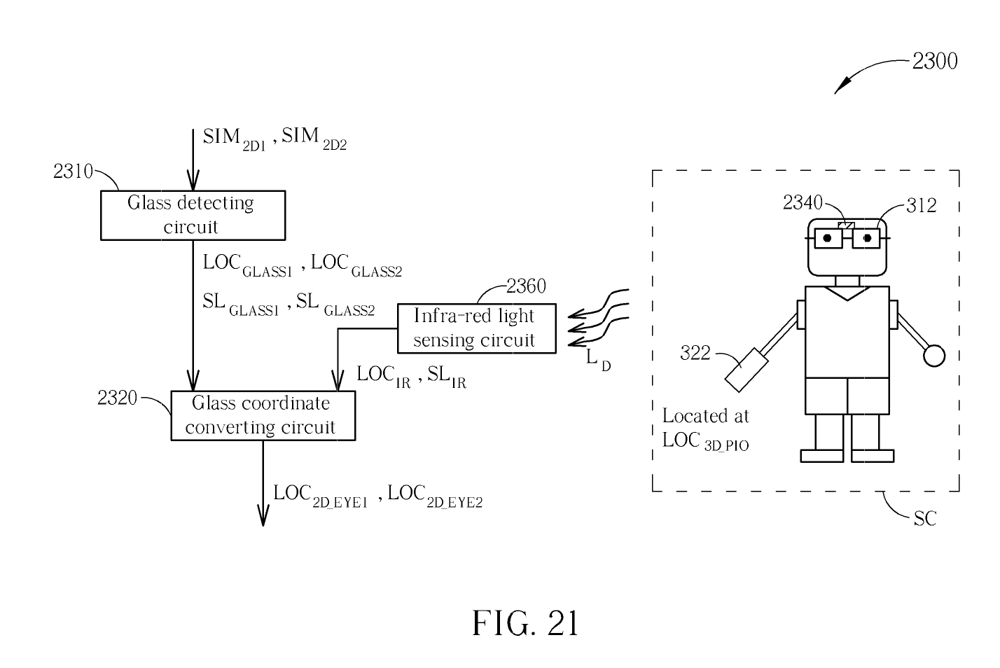

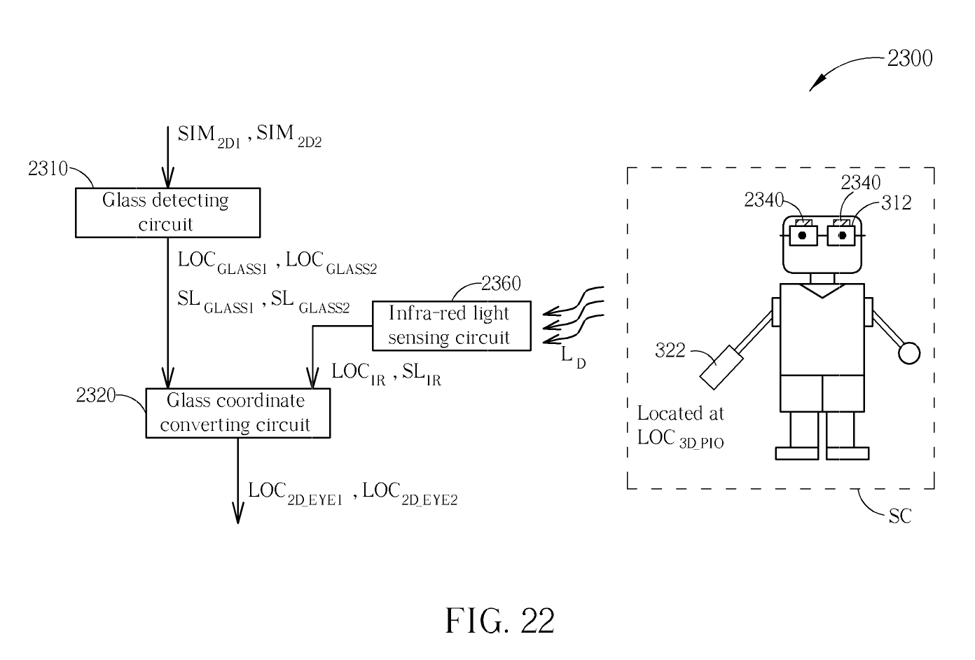

In addition, in the eye positioning circuit 1600 illustrated in FIG. 19 and FIG. 20, when the user moves his head too much, the infra-red reflecting component 1650 may rotate too much so that the infra-red light sensing circuit 1660 can not sense enough energy of the reflecting light L_{R}. In this way, the infra-red light sensing circuit 1660 can not correctly calculate the infra-red light slope SL_{IR}. Therefore, the present invention further provides another embodiment of the eye positioning circuit 2300. FIG. 21 and FIG. 22 are diagrams illustrating the eye positioning circuit 2300. Compared with the eye positioning circuit 1400, the eye positioning circuit 2300 further includes one or more infra-red light emitting components 2340, and an infra-red light sensing circuit 2360. The structures and the operation principles of the infra-red light emitting component 2340 and the infra-red light sensing circuit 2360 are respectively similar to those of the infra-red light emitting component 1640 and the infra-red light sensing circuit 1660. In the eye positioning circuit 2300, the infra-red light emitting component 2340 is directly disposed at the location corresponding to the user's eyes. In this way, when the user move his head too much, the infra-red light sensing circuit 2360 still senses enough energy of the detecting light L_{D} so as the infra-red light sensing circuit 2360 can detect the infra-red light emitting component 2340 and accordingly calculate the infra-red light slope SL_{IR}. In FIG. 21, the eye positioning circuit 2300 includes only one infra-red light emitting component 2340 and the infra-red light emitting component 2340 is approximately disposed in the middle of the user's eyes. In FIG. 22, the eye positioning circuit 2300 includes two infra-red light emitting components 2340 and the two infra-red light emitting components 2340 are respectively disposed above the user's eyes. Hence, compared with the eye positioning circuit 2300 of FIG. 21, in the eye positioning circuit 2300 of FIG. 22, instead of detecting the orientation of the infra-red light emitting component 2340, the infra-red light sensing circuit 2360 detects the two infra-red light emitting components 2340, and can calculate the infra-red light slope SL_{IR} directly according to the locations of the two infra-red light emitting components 2340. In other words, by means of the eye positioning circuit 2300 shown in FIG. 22, the infra-red light slope SL_{IR} is more easily and more accurately calculated so that the 2D eye coordinates LOC_{2D}_{_{—}}_{EYE1} and LOC_{2D}_{_{—}}_{EYE2} can be more correctly calculated.

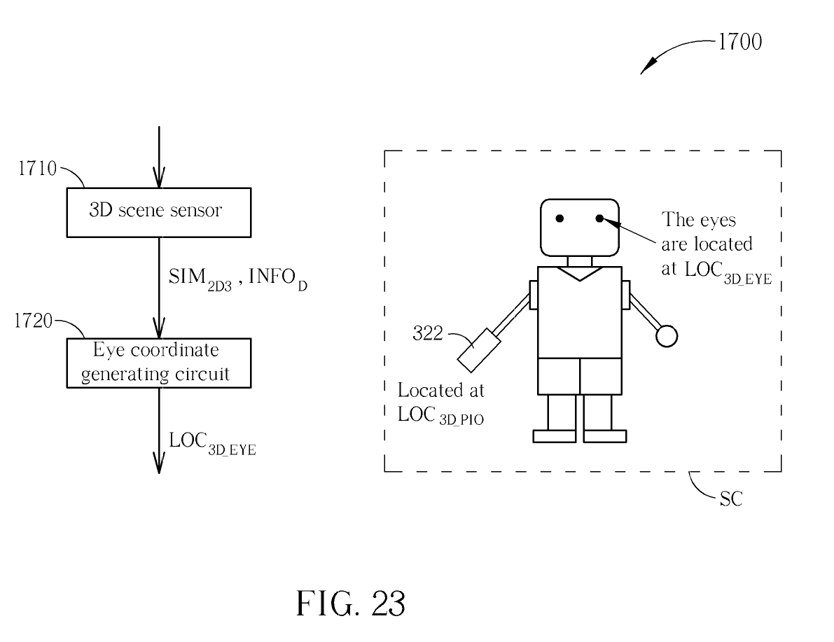

Please refer to FIG. 23. FIG. 23 is a diagram illustrating an eye positioning module 1700 according to another embodiment of the present invention. The eye positioning module 1700 includes a 3D scene sensor 1710, and an eye coordinate generating circuit 1720. The 3D scene sensor 1710 senses the scene SC including the user so as to generate a 2D sensing image SIM_{2D3} and a distance information INFO_{D} corresponding to the 2D sensing image SIM_{2D3}. The distance information INFO_{D} has the data of the distance between each point of the 2D sensing image SIM_{2D3} and the 3D scene sensor 1710. The eye coordinate generating circuit 1720 is utilized for generating the 3D eye coordinate LOC_{3D}_{_{—}}_{EYE} according to the 2D sensing image SIM_{2D3} and the distance information INFO_{D}. For example, the eye coordinate generating circuit 1720 determines which pixels corresponding to the user's eyes in the 2D sensing image SIM_{2D3}. Then, the eye coordinate generating circuit 1720 obtains the distance between the pixels corresponding to the user's eyes in the 2D sensing image SIM_{2D3} and the 3D scene sensor 1710 according to the distance information INFO_{D}. In this way, the eye coordinate generating circuit 1720 generates the 3D eye coordinate LOC_{3D}_{_{—}}_{EYE} according to the location of the pixels of the 2D sensing image SIM_{2D3} corresponding to the user's eyes and the corresponding distance data of the distance information INFO_{D}.

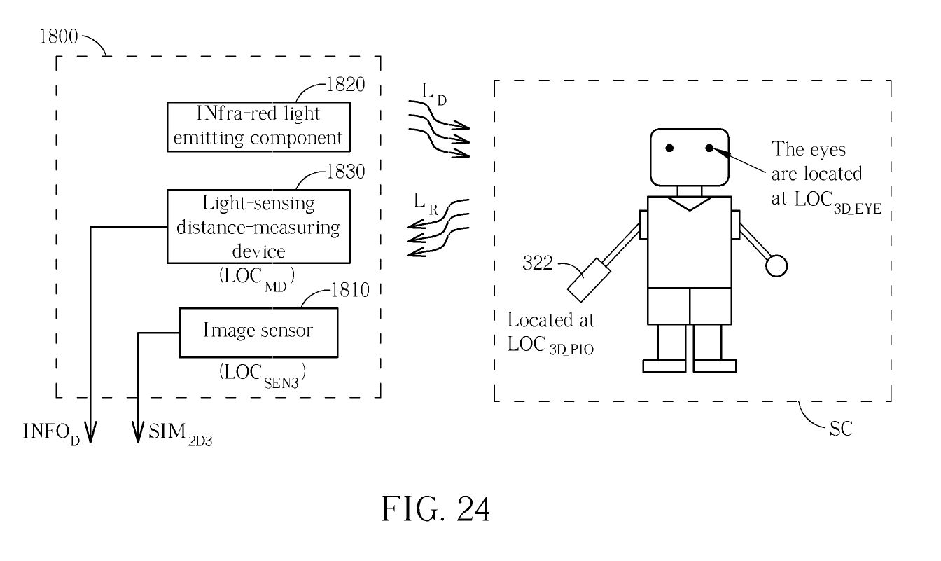

Please refer to FIG. 24. FIG. 24 is a diagram illustrating a 3D scene sensor 1800 according to an embodiment of the present invention. The 3D scene sensor 1800 includes an image sensor 1810, an infra-red light emitting component 1820, and a light-sensing distance-measuring device 1830. The image sensor 1810 senses the scene SC so as to generate the 2D sensing image SIM_{2D3}. The infra-red light emitting component 1820 emits the detecting light L_{D} to the scene SC so that the scene SC generates the reflecting light L_{R}. The light-sensing distance-measuring device 1830 senses the reflecting light L_{R} so as to generate the distance information INFO_{D}. For example, the light-sensing distance-measuring device 1830 is a Z-sensor. The structure and the operation principle of the Z-sensor are well known to those skilled in the art, and are omitted for brevity.

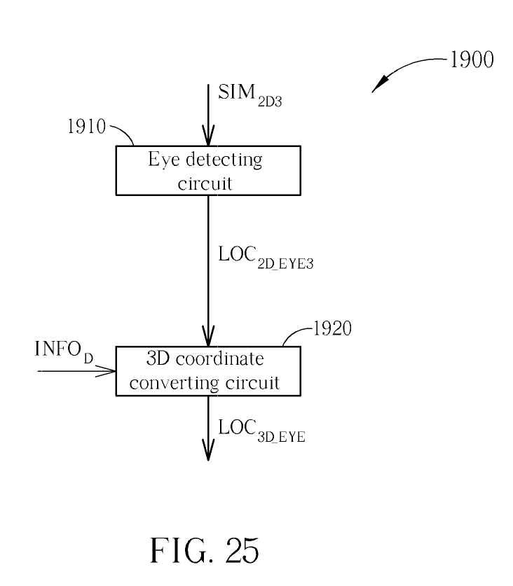

Please refer to FIG. 25. FIG. 25 is a diagram illustrating an eye coordinate generating circuit 1900 according to an embodiment of the present invention. The eye coordinate generating circuit 1900 includes an eye detecting circuit 1910, and a 3D coordinate converting circuit 1920. The eye detecting circuit 1910 is utilized for detecting the user's eyes in the 2D sensing image SIM_{2D3}. The 3D coordinate converting circuit 1920 calculates the 3D eye coordinate LOC_{3D}_{_{—}}_{EYE} according to the 2D eye coordinate LOC_{2D}_{_{—}}_{EYE3}, the distance information INFO_{D}, the distance-measuring location LOC_{MD} of the light-sensing distance-measuring device 1830 (as shown in FIG. 24), and the sensing location LOC_{SEN3} of the image sensor 1810 (as shown in FIG. 24).

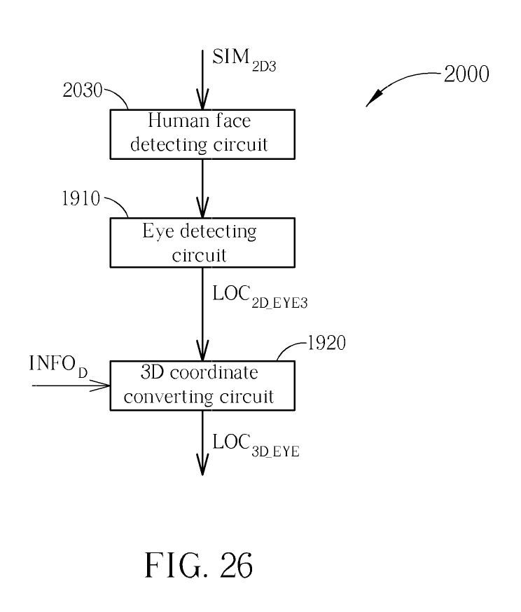

Please refer to FIG. 26. FIG. 26 is a diagram illustrating an eye coordinate generating circuit 2000 according to an embodiment of the present invention. Compared with the eye coordinate generating circuit 1900, the eye coordinate generating circuit 2000 further includes a human face detecting circuit 2030. The human face detecting circuit 2030 is utilized for determining the range of the human face HM₃ of the user in the 2D sensing image SIM_{2D3}. By means of the human face detecting circuit 2030, the eye positioning circuit 1910 only has to process the data of the range of the human faces HM₃ for obtaining the 2D eye coordinates LOC_{2D}_{_{—}}_{EYE3}. Compared with the eye coordinate generating circuit 1900, in the eye coordinate generating circuit 2000, the amount of the data that the eye positioning circuit 1910 has to process in the 2D sensing images SIM_{2D3} is reduced, increasing the processing speed of the eye coordinate generating circuit 2000.

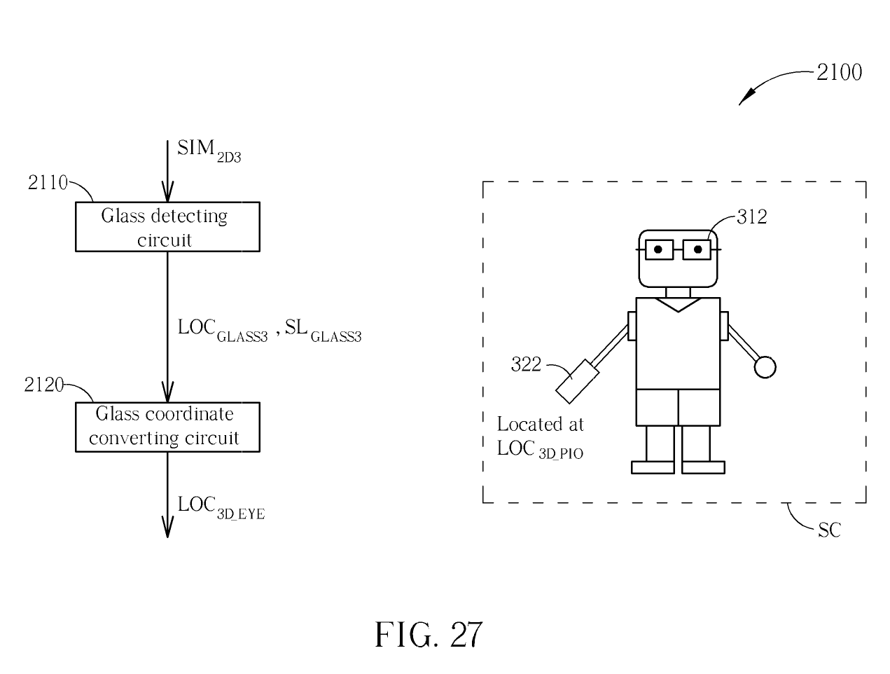

In addition, when the 3D display system 310 is realized with the glass 3D display system, it is possible that the user's eyes are blocked by the assistant glass of the glass 3D display system, so that the user's eyes can not be detected. Therefore, in FIG. 27, the present invention provides an eye coordinate generating circuit 2100 according to another embodiment of the present invention. The eye coordinate generating circuit 2100 includes a glass detecting circuit 2110 and a glass coordinate converting circuit 2120. The glass detecting circuit 2110 detects the assistant glass 312 in the 2D sensing image SIM_{2D3} so as to obtain a 2D glass coordinate LOC_{GLASS3} and a glass slope SL_{GLASS3}. The glass coordinate converting circuit 2120 calculates the 3D eye coordinate LOC_{3D}_{_{—}}_{EYE} according to the 2D glass coordinate LOC_{GLASS3}, the glass slope SL_{GLASS3}, and the predetermined eye spacing D_{EYE}, wherein the predetermined eye spacing D_{EYE} indicates the eye spacing of the user, and the predetermined eye spacing D_{EYE} is a value that the user previously inputs to the 3D interactive system 300 or a default value in the 3D interactive system 300. In this way, even if the user's eyes are blocked by the assistant glass 312, the eye coordinate generating circuit 2100 of the present invention still can obtain the 3D eye coordinate LOC_{3D}_{_{—}}_{EYE3} of the user.

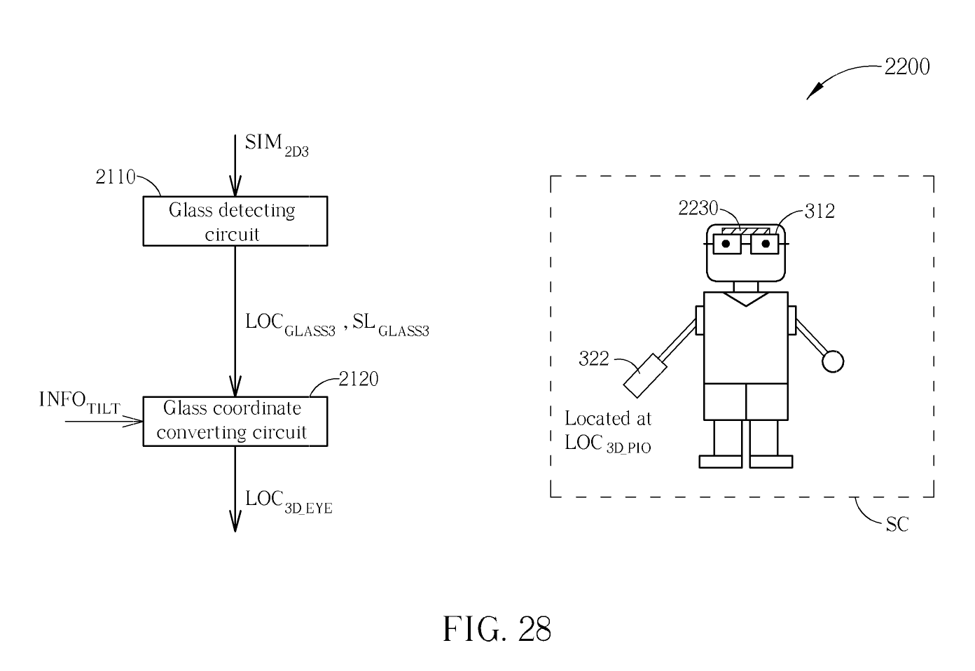

Please refer to FIG. 28. FIG. 28 is a diagram illustrating an eye coordinate generating circuit 2200 according to another embodiment of the present invention. Compared with the eye coordinate generating circuit 2100, the eye coordinate generating circuit 2200 further includes a tilt detector 2230. The tilt detect 2230 is disposed on the assistant glass 312. The structure and the operation principle of the tilt detector 2230 are similar to those of the tilt detector 2230, and will not be repeated again for brevity. By means of the tilt information INFO_{TILT} provided by the tilt detector 2230, the eye coordinate generating circuit 2200 can correct the glass slope SL_{GLASS3} calculated by the eye detecting circuit 2110. For instance, the glass coordinate converting circuit 2120 corrects the glass slope SL_{GLASS3} calculated by the eye detecting circuit 2110 according to the tilt information INFO_{TILT} so as to generate a corrected glass slopes SL_{GLASS3}_{_{—}}_{C}. In this way, the glass coordinate converting circuit 2120 calculates the 3D eye coordinate LOC_{3D}_{_{—}}_{EYE} of the user according to the 2D glass coordinate LOC_{GLASS3}, the corrected glass slope SL_{GLASS3}_{_{—}}_{C}, and the predetermined eye spacing D_{EYE}. Compared with the eye coordinate generating circuit 2100, in the eye coordinate generating circuit 2200, the glass coordinate converting circuit 2120 calibrates the error of the glass detecting circuit 2110 calculating the glass slope SL_{GLASS3}, so that the glass coordinate converting circuit 2120 can more correctly calculate the 3D eye coordinate LOC_{3D}_{_{—}}_{EYE} of the user.

In conclusion, the 3D interactive system provided by the present invention, according to the location of the user, calibrates the location of the interactive component, or calibrates the location and the interaction determining condition of the virtual object in the 3D image. In this way, even if the location of the user changes so that the location of the virtual object observed by the user changes as well, the 3D interactive system still can correctly decide the interactive result according to the corrected location of the interactive component, or according to the corrected location and corrected interactive condition of the virtual object. In addition, when the positioning module of the present invention is an eye positioning module, even if the user's eyes are blocked by the assistant glass of the 3D display system, the eye positioning module provided by the present invention still can calculate the locations of the user's eyes according to the predetermined eye spacing, providing a great convenience.

Those skilled in the art will readily observe that numerous modifications and alterations of the device and method may be made while retaining the teachings of the invention.

What is claimed is:

1. An interactive module applied in a 3D interactive system, the 3D interactive system having a 3D display system, the 3D display system being utilized for providing a 3D image, the 3D image having a virtual object, the virtual object having a virtual coordinate and an interaction determining condition, the interactive module comprising:
a positioning module, for detecting a location of a user in a scene so as to generate a 3D reference coordinate;
an interactive component;
an interactive component positioning module, for detecting a location of the interactive component so as to generate a 3D interactive coordinate; and
an interaction determining circuit, for converting the virtual coordinate into a corrected virtual coordinate according to the 3D reference coordinate, and deciding an interactive result between the interactive component and the 3D image according to the 3D interactive coordinate, the corrected virtual coordinate, and the interaction determining condition.

2. The interactive module of claim 1, wherein the interaction determining circuit converts the interaction determining condition into a corrected interaction determining condition according to the 3D reference coordinate; the interaction determining circuit decides the interactive result according the 3D interactive coordinate, the corrected virtual coordinate, and the corrected interaction determining condition; the interaction determining circuit calculates a threshold surface according to a interactive threshold distance and the virtual coordinate; the interaction determining circuit converts the threshold surface into a corrected threshold surface according to the 3D reference coordinate; the corrected interaction determining condition indicates that when the 3D interactive coordinate is within a region covered by the corrected threshold surface, the interactive result represents contact.

3. The interactive module of claim 1, wherein the positioning module is an eye positioning module; the eye positioning module is utilized for detecting locations of user's eyes in the scene so as to generate a 3D eye coordinate as the 3D reference coordinate;
wherein the 3D display system comprises a display screen and an assistant glass; the display screen is utilized for providing a left image and a right image; the assistant glass is utilized for helping the user's eyes to receive the left image and the right image respectively so that the user obtains the 3D image;
wherein the eye positioning module comprises:
a first image sensor, for sensing the scene so as to generate a first 2D sensing image;
a second image sensor, for sensing the scene so as to generate a second 2D sensing image;
an eye positioning circuit, comprising:
a glass detecting circuit, for detecting the assistant glass in the first 2D sensing image so as to obtain a first 2D glass coordinate and a first glass slope, and detecting the assistant glass in the second 2D sensing image so as to obtain a second 2D glass coordinate and a second glass slope; and
a glass coordinate converting circuit, for calculating a first 2D eye coordinate and a second 2D eye coordinate according to the first 2D glass coordinate, the first glass slope, the second 2D glass coordinate, the second glass slope, and a predetermined eye spacing; and
a 3D coordinate converting circuit, for calculating the 3D eye coordinate according to the first 2D eye coordinate, the second 2D eye coordinate, a first sensing location of the first image sensor, and a second sensing location of the second image sensor.

4. The interactive module of claim 3, wherein the eye positioning circuit further comprises a tilt detector; the tilt detector is disposed on the assistant glass;
the tilt detector is utilized for generating a tilt information according to a tilt angle of the assistant glass; the glass coordinate converting circuit calculates the first 2D eye coordinate and the second 2D eye coordinate according to the tilt information, the first 2D glass coordinate, the first glass slope, the second 2D glass coordinate, the second glass slope, and the predetermined eye spacing.

5. The interactive module of claim 3, wherein the eye positioning circuit further comprises:
a first infra-red light emitting component, for emitting a first detecting light; and
an infra-red light sensing circuit, for generating a 2D infra-red light coordinate and an infra-red light slope;
wherein the glass coordinate converting circuit calculates the first 2D eye coordinate and the second 2D eye coordinate according to the 2D infra-red light coordinate, the infra-red light slope, the first 2D glass coordinate, the first glass slope, the second 2D glass coordinate, the second glass slope, and the predetermined eye spacing.

6. The interactive module of claim 1, wherein the positioning module is an eye positioning module; the eye positioning module is utilized for detecting locations of user's eyes in the scene so as to generate a 3D eye coordinate as the 3D reference coordinate;
wherein the 3D display system comprises a display screen and an assistant glass; the display screen is utilized for providing a left image and a right image; the assistant glass is utilized for helping the user's eyes to receive the left image and the right image respectively so that the user obtains the 3D image;
wherein the eye positioning module comprises:
a 3D scene sensor, comprising:
a third image sensor, for sensing the scene so as to generate a third 2D sensing image;
an infra-red light emitting component, for emitting a detecting light to the scene so that the scene generates a reflecting light; and
a light-sensing distance-measuring device, for sensing the reflecting light so as to generate a distance information;
wherein the distance information has data of distance between each point of the third 2D sensing image and the 3D scene sensor; and
an eye coordinate generating circuit, comprising:
a glass detecting circuit, for detecting the assistant glass in the third 2D sensing image so as to obtain a third 2D glass coordinate and a third glass slope; and
a glass coordinate converting circuit, for calculating the 3D eye coordinate according to the third 2D glass coordinate, the third glass slope, a predetermined eye spacing, and the distance information.

7. The interactive module of claim 1, wherein the positioning module is an eye positioning module; the eye positioning module is utilized for detecting locations of user's eyes in the scene so as to generate a 3D eye coordinate as the 3D reference coordinate;
wherein the eye positioning module comprises:
a 3D scene sensor, comprising:
a third image sensor, for sensing the scene so as to generate a third 2D sensing image;
an infra-red light emitting component, for emitting a detecting light to the scene so that the scene generates a reflecting light; and
a light-sensing distance-measuring device, for sensing the reflecting light so as to generate a distance information;
wherein the distance information has the data of distance between each point of the third 2D sensing image and the 3D scene sensor; and
an eye coordinate generating circuit, comprising:
an eye detecting circuit, for detecting the user's eyes in the third 2D sensing image so as to obtain a third 2D eye coordinate; and
a 3D coordinate converting circuit, for calculating the 3D eye coordinate according to the third 2D eye coordinate, the distance information, a distance-measuring location of the light-sensing distance-measuring device, and a third sensing location of the third image sensor.

8. An interactive module applied in a 3D interactive system, the 3D interactive system having a 3D display system, the 3D display system being utilized for providing a 3D image, the 3D image having a virtual object, the virtual object having a virtual coordinate and an interaction determining condition, the interactive module comprising:
a positioning module, for detecting a location of a user in a scene so as to generate a 3D reference coordinate;
an interactive component;
an interactive component positioning module, for detecting a location of the interactive component so as to generate a 3D interactive coordinate; and
an interaction determining circuit, for converting the 3D interactive coordinate into a corrected 3D interactive coordinate according to the 3D reference coordinate, and deciding an interactive result between the interactive component and the 3D image according to the corrected 3D interactive coordinate, the virtual coordinate, and the interaction determining condition.

9. The interactive module of claim 8, wherein the positioning module is an eye positioning module; the eye positioning module is utilized for detecting locations of user's eyes in the scene so as to generate a 3D eye coordinate as the 3D reference coordinate; the interaction determining circuit obtains a 3D left interactive projected coordinate and a 3D right interactive projected coordinate according to the 3D eye coordinate and the 3D interactive coordinate; the interaction determining circuit determines a left reference straight line according to the 3D left interactive projected coordinate and a predetermined left eye coordinate, and determines a right reference straight line according to the 3D right interactive projected coordinate and a predetermined right eye coordinate; the interaction determining circuit obtains the corrected 3D interactive coordinate according to the left reference straight line and the right reference straight line.

10. The interactive module of claim 9, wherein when the left reference straight line and the right reference straight line cross at a cross point, the interaction determining circuit obtains the corrected 3D interactive coordinate according to a coordinate of the cross point; when the left reference straight line and the right reference do not cross, the interaction determining circuit obtains a reference middle point having a minimal sum of distance to the left reference straight line and to the right reference straight line according to the left reference straight line and the right reference straight line; a distance between the reference middle point and the left reference straight line equals to a distance between the reference middle point and the right reference straight line; the interaction determining circuit obtains the corrected 3D interactive coordinate according to a coordinate of the reference middle point.

11. The interactive module of claim 9, wherein the interaction determining circuit obtains a center point according to the left reference straight light and the right reference straight line; the interaction determining circuit determines a search range according to the center point; M search points exist in the search range; the interaction determining circuit determines M points in a coordinate system of the 3D eye coordinate corresponding to the M search points according to the predetermined eye coordinate, the M search points, and the 3D eye coordinate; the interaction determine circuit determines M error distances corresponding to the M points according to locations of the M points and the 3D interactive coordinate, respectively; the interaction determining circuit determines the corrected 3D interactive coordinate according to a K^{th} point of the M points having a minimal error distance; M and K are positive integers, and K≦M;
wherein the interaction determining circuit determines a left search projected coordinate and a right search projected coordinate according to a K^{th} search point of the M search points and the predetermined eye coordinate; the interaction determining circuit obtains the K^{th} point of the M points corresponding to the K^{th} search point of the M search points according to the left search projected coordinate, the right search projected coordinate, and the 3D eye coordinate.

12. The interactive module of claim 8, wherein the positioning module is an eye positioning module; the eye positioning module is utilized for detecting locations of user's eyes in the scene so as to generate a 3D eye coordinate as the 3D reference coordinate;
Wherein M search points exist in a coordinate system of the predetermined eye coordinate; the interaction determining circuit determines M points in a coordinate system of the 3D eye coordinate corresponding to the M search points according to the predetermined eye coordinate, the M search points, and the 3D eye coordinate; the interaction determine circuit determines M error distances corresponding to the M points according to locations of the M points and the 3D interactive coordinate, respectively; the interaction determining circuit determines the corrected 3D interactive coordinate according to a K^{th} point of the M points having a minimal error distance; M and K are positive integers, and K≦M;
wherein the interaction determining circuit determines a left search projected coordinate and a right search projected coordinate according to a K^{th} search point of the M search points and the predetermined eye coordinate; the interaction determining circuit obtains the K^{th} point of the M points corresponding to the K^{th} search point of the M search points according to the left search projected coordinate, the right search projected coordinate, and the 3D eye coordinate.

13. The interactive module of claim 8, wherein the positioning module is an eye positioning module; the eye positioning module is utilized for detecting locations of user's eyes in the scene so as to generate a 3D eye coordinate as the 3D reference coordinate;
wherein the 3D display system comprises a display screen and an assistant glass; the display screen is utilized for providing a left image and a right image; the assistant glass is utilized for helping the user's eyes to receive the left image and the right image respectively so that the user obtains the 3D image;
wherein the eye positioning module comprises:
a first image sensor, for sensing the scene so as to generate a first 2D sensing image;
a second image sensor, for sensing the scene so as to generate a second 2D sensing image;
an eye positioning circuit, comprising:
a glass detecting circuit, for detecting the assistant glass in the first 2D sensing image so as to obtain a first 2D glass coordinate and a first glass slope, and detecting the assistant glass in the second 2D sensing image so as to obtain a second 2D glass coordinate and a second glass slope; and
a glass coordinate converting circuit, for calculating a first 2D eye coordinate and a second 2D eye coordinate according to the first 2D glass coordinate, the first glass slope, the second 2D glass coordinate, the second glass slope, and a predetermined eye spacing; and
a 3D coordinate converting circuit, for calculating the 3D eye coordinate according to the first 2D eye coordinate, the second 2D eye coordinate, a first sensing location of the first image sensor, and a second sensing location of the second image sensor.

14. The interactive module of claim 13, wherein the eye positioning circuit further comprises a tilt detector; the tilt detector is disposed on the assistant glass; the tilt detector is utilized for generating a tilt information according to a tilt angle of the assistant glass; the glass coordinate converting circuit calculates the first 2D eye coordinate and the second 2D eye coordinate according to the tilt information, the first 2D glass coordinate, the first glass slope, the second 2D glass coordinate, the second glass slope, and the predetermined eye spacing.

15. The interactive module of claim 13, wherein the eye positioning circuit further comprises:
a first infra-red light emitting component, for emitting a first detecting light; and
an infra-red light sensing circuit, for generating a 2D infra-red light coordinate and an infra-red light slope;
wherein the glass coordinate converting circuit calculates the first 2D eye coordinate and the second 2D eye coordinate according to the 2D infra-red light coordinate, the infra-red light slope, the first 2D glass coordinate, the first glass slope, the second 2D glass coordinate, the second glass slope, and the predetermined eye spacing.

16. The interactive module of claim 8, wherein the positioning module is an eye positioning module; the eye positioning module is utilized for detecting locations of eyes of a user in the scene so as to generate a 3D eye coordinate as the 3D reference coordinate;
wherein the 3D display system comprises a display screen and an assistant glass; the display screen is utilized for providing a left image and a right image; the assistant glass is utilized for helping the user's eyes to receive the left image and the right image respectively so that the user obtains the 3D image;
wherein the eye positioning module comprises:
a 3D scene sensor, comprising:
a third image sensor, for sensing the scene so as to generate a third 2D sensing image;
an infra-red light emitting component, for emitting a detecting light to the scene so that the scene generates a reflecting light; and
a light-sensing distance-measuring device, for sensing the reflecting light so as to generate a distance information; −wherein the distance information has the data of distance between each point of the third 2D sensing image and the 3D scene sensor; and
an eye coordinate generating circuit, comprising:
a glass detecting circuit, for detecting the assistant glass in the third 2D sensing image so as to obtain a third 2D glass coordinate and a third glass slope; and
a glass coordinate converting circuit, for calculating the 3D eye coordinate according to the third 2D glass coordinate, the third glass slope, a predetermined eye spacing, and the distance information.

17. The interactive module of claim 8, wherein the positioning module is an eye positioning module; the eye positioning module is utilized for detecting locations of eyes of a user in the scene so as to generate a 3D eye coordinate as the 3D reference coordinate;
wherein the eye positioning module comprises:
a 3D scene sensor, comprising:
a third image sensor, for sensing the scene so as to generate a third 2D sensing image;
an infra-red light emitting component, for emitting a detecting light to the scene so that the scene generates a reflecting light; and
a light-sensing distance-measuring device, for sensing the reflecting light so as to generate a distance information;
wherein the distance information has the data of distance between each point of the third 2D sensing image and the 3D scene sensor; and
an eye coordinate generating circuit, comprising:
an eye detecting circuit, for detecting the user's eyes in the third 2D sensing image so as to obtain a third 2D eye coordinate; and
a 3D coordinate converting circuit, for calculating the 3D eye coordinate according to the third 2D eye coordinate, the distance information, a distance-measuring location of the light-sensing distance-measuring device, and a third sensing location of the third image sensor.

18. A method of deciding an interactive result of a 3D interactive system, the 3D interactive system having a 3D display system and an interactive component, the 3D display system being utilized for providing a 3D image, the 3D image having a virtual object, the virtual object having a virtual coordinate and an interaction determining condition, the method comprising:
detecting a location of a user in a scene so as to generate a 3D reference coordinate;
detecting a location of the interactive component so as to generate a 3D interactive coordinate; and
deciding the interactive result between the interactive component and the 3D image according to the 3D reference coordinate, the 3D interactive coordinate, the virtual coordinate, and the interaction determining condition.

19. The method of claim 18, wherein detecting the location of the user in the scene so as to generate the 3D reference coordinate comprises detecting locations of user's eyes in the scene so as to generate a 3D eye coordinate as the 3D reference coordinate;
wherein deciding the interactive result between the interactive component and the 3D image according to the 3D reference coordinate, the 3D interactive coordinate the virtual coordinate, and the interaction determining condition comprises:
converting the virtual coordinate into a corrected virtual coordinate according to the 3D eye coordinate; and
deciding the interactive result according to the 3D interactive coordinate, the corrected virtual coordinate, and the interaction determining condition.

20. The method of claim 18, wherein detecting the location of the user in the scene so as to generate the 3D reference coordinate comprises detecting locations of user's eyes in the scene so as to generate a 3D eye coordinate as the 3D reference coordinate;
wherein deciding the interactive result between the interactive component and the 3D image according to the 3D reference coordinate, the 3D interactive coordinate the virtual coordinate, and the interaction determining condition comprises:
converting the virtual coordinate into a corrected virtual coordinate according to the 3D eye coordinate;
converting the interaction determining condition into a corrected interaction determining condition; and
deciding the interactive result according to the 3D interactive coordinate, the corrected virtual coordinate, and the corrected interaction determining condition;
wherein converting the interaction determining condition into the corrected interaction determining condition comprises:
calculating a threshold surface according to an interactive threshold distance and the virtual coordinate; and
converting the threshold surface into a corrected threshold surface according to the 3D eye coordinate;
wherein the corrected interaction determining condition indicates that when the 3D interactive coordinate is within a region covered by the corrected threshold surface, the interactive result represents contact.

21. The method of claim 18, wherein detecting the location of the user in the scene so as to generate the 3D reference coordinate comprises detecting locations of user's eyes in the scene so as to generate a 3D eye coordinate as the 3D reference coordinate;
wherein deciding the interactive result between the interactive component and the 3D image according to the 3D reference coordinate, the 3D interactive coordinate the virtual coordinate, and the interaction determining condition comprises:
converting the 3D interactive coordinate into a corrected 3D interactive coordinate according to the 3D eye coordinate; and
deciding the interactive result according to the corrected 3D interactive coordinate, the virtual coordinate, and the interaction determining condition;
wherein the interaction determining condition indicates that when a distance between the corrected 3D interactive coordinate and the virtual coordinate is shorter than a interactive threshold distance, the interactive result represents contact.

22. The method of claim 21, wherein converting the 3D interactive coordinate into the corrected 3D interactive coordinate according to the 3D eye coordinate comprises:
obtaining a 3D left interactive projected coordinate and a 3D right interactive projected coordinate which the interactive component projects to the 3D display system according to the 3D eye coordinate and the 3D interactive coordinate;
determining a left reference straight line according to the 3D left interactive projected coordinate and a predetermined left eye coordinate, and determining a right reference straight line according to the 3D right interactive projected coordinate and a predetermined right eye coordinate; and
obtaining the corrected 3D interactive coordinate according to the left reference straight line and the right reference straight line.

23. The method of claim 22, wherein obtaining the corrected 3D interactive coordinate according to the left reference straight line and the right reference straight line comprises:
when the left reference straight line and the right reference straight line cross at a cross point, obtaining the corrected 3D interactive coordinate according to a coordinate of the cross point; and
when the left reference straight line and the right reference do not cross, obtaining a reference middle point having a minimal sum of distance to the left reference straight line and to the right reference straight line according to the left reference straight line and the right reference straight line, and obtaining the corrected 3D interactive coordinate according to a coordinate of the reference middle point;
wherein a distance between the reference middle point and the left reference straight line equals to a distance between the reference middle point and the right reference straight line.

24. The method of claim 22, wherein obtaining the corrected 3D interactive coordinate according to the left reference straight line and the right reference straight line comprises:
obtaining a center point according to the left reference straight line and the right reference straight line;
determining a search range according to the center point;
wherein M search points exist in the search range;
determining M points corresponding to the M search points according to the predetermined eye coordinate, the M search points, and the 3D eye coordinate;
respectively determining M error distances, which corresponds to the M points, between locations of the M points and the 3D interactive coordinate; and
determining the corrected 3D interactive coordinate according to a K^{th} point of the M points having a minimal error distance;
wherein M and K are positive integers, and K≦M;
wherein determining the M points corresponding to the M search points according to the predetermined eye coordinate, the M search points, and the 3D eye coordinate comprises:
determining a left search projected coordinate and a right search projected coordinate according to a K^{th} search point of the M search points and the predetermined eye coordinate; and
obtaining the K^{th} point of the M points corresponding to the K^{th} search point of the M search points according to the left search projected coordinate, the right search projected coordinate, and the 3D eye coordinate.

25. The method of claim 21, wherein converting the 3D interactive coordinate into the corrected 3D interactive coordinate according to the 3D eye coordinate comprises:
In a coordinate system of the 3D eye coordinate, determining M points corresponding to the M search points according to the predetermined eye coordinate, the M search points in a coordinate system of the predetermined eye coordinate, and the 3D eye coordinate;
respectively determining M error distances, which corresponds to the M points, between locations of the M points and the 3D interactive coordinate; and
determining the corrected 3D interactive coordinate according to a K^{th} point of the M points having a minimal error distance;
wherein M and K are positive integers, and K≦M;
wherein in the coordinate system of the 3D eye coordinate, determining the M points corresponding to the M search points according to the predetermined eye coordinate, the M search points in the coordinate system of the predetermined eye coordinate, and the 3D eye coordinate comprises:
determining a left search projected coordinate and a right search projected coordinate according to a K^{th} search point of the M search points and the predetermined eye coordinate; and
obtaining the K^{th} point of the M points corresponding to the K^{th} search point of the M search points according to the left search projected coordinate, the right search projected coordinate, and the 3D eye coordinate.
